(19) United States
(12) Patent Application Publication
(10) Pub. No.: US 2009/0116402 A1
(43) Pub. Date: May 7, 2009

(54) COMMUNICATION QUALITY MEASURING APPARATUS AND COMMUNICATION QUALITY MEASURING METHOD

(75) Inventor: Yasuhiro Yamasaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, MINATO-KU TOKYO (JP)

(21) Appl. No.: 11/577,799

(22) PCT Filed: Oct. 20, 2005
(86) PCT No.: PCT/JP05/19295

§ 371 Date: Apr. 23, 2007

(30) Foreign Application Priority Data
Oct. 21, 2004 (JP) 2004-306882

(51) Int. Cl. G06F 11/30

(52) U.S. Cl. 370/253

(57) ABSTRACT

A measuring apparatus for measuring quality of a network accurately measures a number of times of a data loss even if all the packets to be measured are not obtained or cannot be obtained. Further, a process load applied to the measuring apparatus is decreased by processing a part of the packets to be measured.

The measuring apparatus, which measures quality of a network, includes a means for estimating a sampling rate from a number showing sequences stored in packets and a number of received data and a means for estimating a data loss, which would be measured when all the packets were obtained, from a result of sampling measurement by carrying out a differential process and a statistical process using the sequences in the packets, thereby the measuring apparatus measures a number of times of the data loss in the sampling measurement.

### TECHNICAL FIELD

The present invention relates to a communication quality measuring apparatus for and a communication quality measuring method of measuring communication quality of a network.

### BACKGROUND ART

Quality of a network processed by the present invention means quality of a packet input to a measuring apparatus. A packet is input to the measuring apparatus from a branching apparatus interposed between communication terminals. Further, quality of a packet means throughput, goodput, a packet loss, and RTT (Round Trip Time).

An apparatus for measuring quality of a network will be explained below using TCP (Transmission Control Protocol) as an example for simplification.

Patent Document 1 will be explained here.

A method of measuring goodput and packet loss disclosed in Patent Document 1 will be explained using FIGS. 1, 2, and 3.

FIG. 1 is a view showing a scope to which Patent Document 1 is applied, FIG. 2 is a block diagram of Patent Document 1, and FIG. 3 is a view showing a flow of processing carried out by Patent Document 1.

When quality of a packet communication between communication terminals 2 and 3 is measured, branching apparatuses 4 and 5 are installed on the communication link thereof, and a packet of a communication to be measured is fetched by a measuring apparatus 1 to thereby start measurement of the quality.

FIG. 2 shows the block diagram of Patent Document 1.

First, terms will be defined below.

The number of sets of the same ACKs means the number of sets of the same ACKs that appear continuously (at least three times). The term ACK used here is abbreviation of “acknowledgement”.

The number of the same ACKs means a number of the same ACKs that appear continuously.

A measuring apparatus 1a in Patent Document 1 is composed of a data receiving device 111 to which data from the branching apparatus 4 is input, a data receiving device 112 to which data from the branching apparatus 5 is input, a flow identifying device 120 for identifying the input data of each flow, an ACK information determination device 1000a for measuring quality only from ACK side information, a goodput measuring unit 130a included in the ACK information determination device 1000a, a storage unit 131a for storing an initial ACK number in a monitor period, a storage unit 132a for storing the final ACK number in the monitor period, a goodput calculation unit 133a for calculating goodput from the contents stored in the storage units 131a and 132a, a packet loss measuring unit 140a, a number of sets of same ACK storage unit 141a for counting the number times of appearance the same ACK number that continuously appears at least three times, a calculation unit 143a for counting a number of times of packet losses from the result of the above count, a DATA information determination device 2000a for measuring quality only from DATA side information (sequence number, hereinafter, abbreviated as SN) a goodput calculation unit 230a in the DATA information determination device 2000a, a storage unit 231a for storing an initial DATA number in the monitor period, a storage unit 233a for storing a final DATA number in the monitor period, a goodput calculation unit 233a for calculating goodput from the contents stored in the storage units 231a and 232a, a packet loss calculation unit 240a, a difference of SN numbers confirmation unit 241a for comparing obtained DATA with the maximum SN counted in the past, and a number of times of packet losses calculation unit 243a for counting a number of times of a packet loss based on a result of the comparison.

In Patent Document 1, a process is started by fetching data flowing on the network by the measuring apparatus 1a. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies the flow of the received data based on a transmission/reception IP address, a transmission/reception TCP port number, a protocol number, and the like. When data to be processed is the ACK side information, it is processed by the ACK information determination device 1000a, whereas when it is the DATA side information, it is processed by the DATA information determination device 2000a.

The DATA information determination device 1000a measures goodput and a packet loss in each predetermined monitor period. To calculate the goodput, the goodput calculation unit 130a stores an ACK number it receives first in the monitor period to the ACK number storage unit 131a. At the same time, each time ACK is received, the ACK number storage unit 132a updates a latest ACK number. Each time the monitor period is updated, a goodput calculation process is carried out by calculating “the ACK number of the ACK number storage unit 132a—the ACK number of the ACK number storage unit 131a” by the goodput calculation unit 133a. In the calculation of the packet loss, it is determined whether or not the same ACK number continuously appears at least three times in the number of sets of same ACK storage unit 141a. When the same ACK number continuously appears at least three times in the determination processing, it is determined that the packet loss occurs. The number of times of packet loss calculation unit 143a increments the number of times of packet losses by 1 each time the number of sets of same ACK storage unit 141a determines that a packet loss occurs. When the monitor period is updated, the number of times of packet losses occurred in the period is fixed, and the count of the packet loss is reset to 0 for the next monitor period.

The DATA information determination device 2000a measures goodput and a packet loss in each predetermined monitor period. To calculate the goodput, the goodput calculation unit 230a stores an SN number it receives first in the monitor period to the DATA number storage unit 231a. At the same time, each time DATA is received, the DATA number storage unit 232a updates a latest DATA number. At the time, when an SN number smaller than that received in the past is received, the update job is not carried out. Each time the monitor period is updated, a goodput calculation process is carried out by calculating “the SN number number of the DATA number storage unit 232a—the SN number of the DATA number storage unit 231a” by the goodput calculation unit 233a. In the calculation of the packet loss, the difference of SN numbers confirmation unit 241a determines that the packet loss occurs each time it receives an SN number smaller than the maximum SN number it received in the past. The number of times of packet loss calculation unit 243a increments the number of times of packet losses by 1 each time the difference of SN numbers confirmation unit 241a determines that a packet loss occurs. When the monitor period is updated, the number of the packet loss occurred in the period is fixed, and the count of the packet loss is reset to 0 for the next monitor period.

Next, a process for calculating quality of “goodput” and “packet loss” carried out by the measuring apparatus 1a will be explained with reference to FIG. 3. A result of quality of “goodput” and “packet loss” in the network is calculated at each predetermined monitor time.

FIG. 3 shows an outline of a process flow in Patent Document 1.

The measuring apparatus 1a starts a process when data is input from the branching apparatus 4 or 5 and reaches the data receiving device 111 or 112. This process is a process A-1. After the completion of the process A-1, it goes to a process A-2.

The process A-2 is a process for identifying the same flow. The flow identifying device 120 carries out the process for identifying the flow of received data based on a transmission/reception IP address, a transmission/reception TCP port number, a protocol number, and the like. After the completion of the flow identifying process, the process A-2 goes to a process A-3.

In the process A-3, it is determined whether the input data has the ACK side information of the flow or the SN side information thereof. When the input data has the ACK side information, the process A-3 goes to a process A-4, whereas when the input data has the SN side information, the process A-3 goes to a process A-10. Note that since TCP communication is arranged such that one data can include the ACK side information and the SN side information therein, ACK side information data of a flow may become SN side information data of other flow.

In the process A-4, it is confirmed whether or not a monitor section was updated from the time at which data was received last time. When the monitor section was updated, the process A-4 goes to a process A-5 to calculate a result of quality of a previous monitor section. When the monitor section was not updated, the process A-4 goes to a process A-7 to continuously monitor the quality of a present monitor section.

In the process A-5, a result of quality (goodput, packet loss) of the previous monitor section is fixed. Goodput is obtained by calculating “the number of the ACK number at end-of-period storage unit 132a—the number of the ACK number at beginning-of-period storage unit 131a”. The value of the number of times of packet loss calculation unit 143a is fixed as the packet loss. Thereafter, the value of the number of times of packet loss calculation unit 143a is reset to 0 for a present monitor section. After the completion of the process A-5, it goes to a process A-6.

In the process A-6, the ACK number received first in the present monitor section is stored to the ACK number at beginning-of-period storage unit 131a. After the completion of the process A-6, it goes to the process A-7.

In the process A-7, each time an ACK packet is received, its number is updated. The number of a finally received ACK packet is stored to the ACK number at end-of-period storage unit 132a. After the completion of the process A-7, it goes to a process A-8.

In the process A-8, it is confirmed whether or not the ACK number agrees with the number received previous time, and when they agree with each other, it is confirmed whether or not they agree with each other three times continuously (the number of sets of same ACK storage unit 141a). In the TCP, when a packet loss is recognized on a receiving terminal side, since the same ACK number is continuously transmitted to a transmission side, whether or not the packet loss occurs is confirmed by the process. When the same ACK number continuously appears three times, the process A-8 goes to a process A-9 to count the number of times of packet losses of the present monitor section. In a case other than the case in which the same ACK number continuously appears three times, since it is determined that no packet loss occurs, it is waited that next data is input, and the process to the present packet is finished.

In the process A-9, the number of times of packet losses in the present monitor section is counted. Since it is determined in the process A-8 that the packet loss occurs, the value of the number of times of packet loss calculation unit 143a is incremented by 1. With this processing, the process to the present packet is finished, and it is waited that next data is input.

In the process A-10, it is confirmed whether or not the monitor section is updated from the time at which the previous data was received. When the monitor section is updated, the process A-10 goes to a process A-11 to calculate a result of quality of a previous monitor section. When the monitor section was not updated, the process A-10 goes to a process A-13 to continuously monitor the quality of the present monitor section.

In the process A-11, a result of quality (goodput, packet loss) of the previous monitor section is fixed. Goodput is obtained by calculating “the SN number of the end-of-period storage unit 232a—the SN number at beginning-of-period storage unit 231a” are calculated. The value of the number of times of packet loss calculation unit 243a is fixed as the packet loss. Thereafter, the value of the number of times of packet loss calculation unit 243a is reset to 0 for the present monitor section. After the completion of the process A11, it goes to a process A-12.

In the process A-12, the SN number received first in the present monitor section is stored to the SN number at beginning-of-period storage unit 231a. However, when the maximum SN number received in the past is larger the value received this time, the past maximum SN number is stored to the SN number at beginning-of-period storage unit 231a. After the completion of the process A-12, it goes to the process A-13.

In the process A-13, each time a DATA packet is received, its value is updated. The SN number of a finally received DATA packet is stored to the SN number at end-of-period storage unit 232a. However, when the maximum SN number received in the past is larger the value received this time, the past maximum SN number is stored to the SN number at end-of-period storage unit 232a. After the completion of the process A-14, it goes to a process A-14.

In the process A-14, the maximum SN number received in the past is compared with the SN of the packet received this time. When an SN reverse phenomenon of the maximum SN number received in the past >the SN of the packet received this time occurs, it is recognized that a packet loss occurs. Thus, the process A-14 goes to a process A-15 to count the packet loss. When the SN reverse phenomenon does not occur, it is determined that no packet loss occurs, and the process to the present packet is finished. Then, it is waited that next data is input.

In the process A-15, the number of times of packet losses in the present monitor section is counted. Since it is determined in the process A-14 that the packet loss occurs, the value of the number of times of packet loss calculation unit 243a is incremented by 1. With this processing, the process to the present packet is finished, and it is waited that next data is input.

The calculation of quality of the method is employed also in Non-patent Documents 1 and 2 as one of ordinary quality calculation methods.

Patent Document 1: Japanese Patent Application Laid-Open Publication No. 2001-285400

Non-Patent Document 1: Design of Performance Monitor for Collecting Statistic Information of TCP level from IP Traffic in One Direction, Tomohiko Ogishi, Akira Idogami, Toru Hasegawa, Tetsuhiko Kato, General Assembly of 2000 of The Institute of Electronics, Information, and Communication Engineers

Non-Patent Document 2: Method of Specifying Bottlenecks Based on Measurement in the Internet, Kazumine Matoba, Shingo Ata, Masayuki Murata, Assembly for Studying Telecommunication Management, The Institute of Electronics, Information, and Communication Engineers, PP 65-70, November, 2000

### DISCLOSURE OF THE INVENTION

A first problem of the first method resides in that requires a sophisticated calculation capability to measure quality of a flow.

This is because, in the first method, all the packets of a flow to be measured must be measured. Accordingly, since the number of packets to be calculated is greatly increased in a high speed network, the sophisticated calculation capability is required to process all the packets.

A second problem of the first method resides in that when all the packets of the flow to be measured cannot be obtained, quality cannot be correctly measured.

This is because, in the first method, the packet loss is simply counted by the number of times in which a duplicated ACK number appears. Accordingly, when a duplicated packet cannot be obtained regardless that an ACK number is duplicated originally, the packet loss is not counted. As a result, quality cannot be correctly counted.

Accordingly, an object of the present invention, which was made in view of the above problems, + is to permit a measuring apparatus to measure quality of “throughput”, “goodput”, “packet loss”, and “RTT” between communication terminals with a low calculation capability. Further, an object of the present invention is to make it possible to measure quality even if all the packets cannot be obtained.

In a measuring apparatus 1 according to the present invention, quality of thinned-out packets is measured by a sampling device 170. As a result, since it is not necessary to carry out a calculation process to all the packets, it is not necessary to require a sophisticated calculation capability to the measuring apparatus.

In the measuring apparatus 1 according to the present invention, a sampling rate can be estimated even if an ACK sampling rate estimation unit 180 and a DATA sampling rate estimation unit do not to thin out some packets by mistake in a portion that is not controlled by the measuring apparatus. As a result, since it is possible to carry out sampling even if a sampling rate is already known in the measuring apparatus 1, it is not necessary to carry out the calculation process to all the packets, thereby the sophisticated calculation capability is not required to the measuring apparatus.

In the measuring apparatus 1 according to the present invention, a quality determination device 200, a sampling rate decision device 210, and the sampling device 170 minutely monitor a flow which must be intensively monitored (by increasing the sampling rate to packets) and roughly monitor a flow which may be less intensively monitored (by decreasing the sampling rate for packets). As a result, it is possible to set the sampling rate to the packets of each flow to an optimum value, thereby the sophisticated calculation capability is not required to the measuring apparatus.

To make it possible to measure quality of a network (goodput) by sampling, goodput is calculated by an ACK number at end-of-previous-monitor-period storage unit 131b, an ACK number at end-of-monitor-period storage unit 132b in a monitor section to be updated at the time, and a goodput calculation unit 133b of a goodput calculation unit 130b based on the information of the storage units 131b, 132b. As a result, correct goodput can be calculated even if it is measured by the sampling.

To make it possible to measure quality of a network (goodput) by the sampling, goodput is calculated by an SN number at end-of-previous-monitor-period storage unit 231d, an SN number at end-of-monitor-period storage unit 232d in a monitor section to be updated at the time, and a goodput calculation unit 233d of a goodput calculation unit 230b based on the information of the storage units 231d, 232d. As a result, correct goodput can be calculated even if it is measured by the sampling.

To make it possible to measure quality of the network (packet loss) by the sampling how many times the same ACKs appear when no sampling is carried out is estimated by the number of same ACK storage unit 141b, a statistic processing unit 142b, and a number of times of packet loss calculation unit 143b of a packet loss measuring unit 140b from the number of times of appearance of the same ACKs detected in the sampling and a sampling rate. As a result, a correct packet loss can be estimated even if all the same ACKs cannot be detected because the measurement is carried out by the sampling.

To make it possible to measure quality of the network (packet loss) by the sampling, an ACK number differential processing unit 141c and a number of times of packet loss calculation unit 143c of a packet loss measuring unit 140c estimate a packet loss from the variation of a result of differentiation of an ACK number. As a result, a correct packet loss can be estimated even if all the ACKs cannot be detected because the measurement is carried out by the sampling.

To make it possible to measure quality of the network (packet loss) by the sampling, an SN number differential processing unit 241d and a number of times of packet losses calculation unit 243d of a packet loss measuring unit 240d estimate a packet loss from the variation of a result of differentiation of an SN number. As a result, a correct packet loss can be estimated even if all the SNs cannot be detected because the measurement is carried out by the sampling.

To make it possible to measure quality of the network (throughput) by the sampling, throughput is calculated by a throughput calculation unit 151b of a throughput measuring unit 150b from obtained goodput and packet loss. As a result, a correct packet loss can be estimated even if all the packets cannot be obtained because the measurement is carried out by the sampling.

To make it possible to measure quality of the network (throughput) by the sampling, throughput is calculated by a throughput calculation unit 251d of a throughput measuring unit 205d from the theoretical interpretation of the behavior of obtained goodput, packet loss, and TCP. As a result, correct throughput can be estimated even if all the packets cannot be obtained because the measurement is carried out by the sampling.

To make it possible to measure quality (RTT) of the network by the sampling, RTT is calculated by an RTT calculation unit 161b of an RTT measuring unit 160b from the theoretical interpretation of the behavior of the obtained goodput, packet loss, and TCP. As a result, the RTT can be estimated even if all the packets cannot be obtained because the measurement is carried out by the sampling.

The measuring apparatus 1 according to the present invention makes it is possible to carry out the measurement by the sampling by the goodput measuring units 130b, 130c, 230d, the packet loss measuring units 140b, 140c, and 240d, the throughput calculation units 150b and 250d, and the RTT measuring unit 160b. As a result, quality can be accurately measured even if all the packets of a flow to be measured cannot be obtained.

According to the present invention, a network quality measuring method of measuring quality of a network is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which cannot be measured in the certain period were obtained and calculated.

According to the present invention, a network quality measuring method of measuring quality of a network is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which are not measured in the certain period were obtained and calculated.

According to the present invention, a network quality measuring method of measuring quality of a network is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which are not measured in the certain period were obtained and calculated.

According to the present invention, a network quality measuring method of measuring quality of a network is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which cannot be measured in the certain period were obtained and calculated.

According to the present invention, a network quality measuring method of measuring quality of a network is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which are not measured in the certain period were obtained and calculated.

According to the present invention, a network quality measuring method of measuring quality of a network is characterized by including a step of using the information in a part of a certain period during which transmission data is transmitted from a data reception side to a data transmission side as a target to be measured and calculating a number of times of a data loss, a data loss rate, a data loss time, and a data loss packet, which would be calculated when all the information including the information which is not measured in the certain period was obtained and calculated.

According to the present invention, a network quality measuring method of measuring quality of a network is characterized by including a step of using the information in a part of a certain period during which transmission data is transmitted from a data reception side to a data transmission side and the packets in a part of a certain period during which a reception confirmation signal is transmitted from the data reception side to the data transmission side and calculating a number of times of a data loss, a data loss rate, and a data loss time, which would be calculated when all the packets including the packets which cannot be measured in the certain period were obtained and calculated.

The network quality measuring method may include a step of measuring a number of changes of the data transmission sequence of the transmission data transmitted from the data transmission side to the data reception side, a step of measuring the number of the transmission data, and a step of calculating a sampling rate of packets from the number of changes of the data transmission sequence and the number of the transmission data.

The network quality measuring method may include a step of measuring a number of changes of the data transmission sequence of the transmission data transmitted from the data transmission side to the data reception side, a step of measuring the number of the transmission data, and a step of calculating a sampling rate of packets from the number of changes of the data transmission sequence, the number of the transmission data, and a past data loss rate or the number of times of a past data loss.

The network quality measuring method may include a step of measuring a number of changes of a confirmation response number of the confirmation response signal transmitted from the data reception side to the data transmission side, a step of measuring the number of the confirmation response signal, and a step of calculating a sampling rate of packets from the number of changes of the confirmation response number and a number of confirmation signals.

The network quality measuring method may include a step of measuring a number of changes of a confirmation response number of the confirmation response signal transmitted from the data reception side to the data transmission side, a step of measuring a number of the confirmation response signal, and a step of calculating a sampling rate of packets from the number of changes of the confirmation response number, the number of the confirmation signal, and a past data loss rate or a number of times of a past data loss.

The network quality measuring method may include a step of obtaining packets sampled at a designated sampling rate.

The network quality measuring method may include a quality determination step of determining quality from a result of calculated network quality, a step of deciding a sampling rate based on the result of the quality determination, and a step of obtaining packets sampled at the decided sampling rate.

The network quality measuring method may include a step of deciding a sampling rate from a load state of a measuring apparatus, and a step of obtaining packets at the decided sampling rate.

The network quality measuring method may include a step of deciding a sampling rate from the quality determined from a result of measured network quality and the load state of a measuring apparatus, and a step of obtaining packets at the decided sampling rate.

The network quality measuring method may include a step of measuring a number of times of appearance of the same confirmation response signal obtained by sampling when it appears at least an arbitrary designated number of times, and a step of calculating a number of times of appearance of the same confirmation response signal, which would be measured when all the packets were obtained and measured, using the number of times measured above and a probability distribution model.

The network quality measuring method may use at least one of normal distribution, standard normal distribution, chi-square distribution, F-distribution, t-distribution, beta-distribution, exponential distribution, gamma distribution, binominal distribution, hypergeometrical distribution, exponential normal distribution, Poisson distribution, negative binominal distribution, Weibull distribution, and regular distribution as the probability distribution model of the number of times of appearance of the same confirmation response signal.

The network quality measuring method may determine parameters such as an average value, a variance value, a covariance value, and the like which are necessary in probability distribution from a number of times of a past data loss, a past data loss rate, and a sampling probability.

The network quality measuring method may repeat a process a plurality of times in one monitor period to calculate a number of times of a packet loss from the calculated number of times of appearance of the confirmation response signal as a step of calculating a number of times of appearance of the confirmation response signal.

The network quality measuring method may include a step of calculating a number of times of appearance of the confirmation response signal, which would be calculated when all the packet were obtained, by estimating that a number of times in which the same confirmation response signal obtained by sampling appears at least an arbitrary number of times which corresponds to a probability having at least a certain value of the probability distribution model.

The network quality measuring method may include a step of calculating a number of times of a data loss, a data loss rate, and a data loss time which would be obtained when all the packets were obtained by carrying out n-degree differentiation to a difference between a data transmission sequence of the transmission data transmitted from the data transmission side to the data reception side and a certain criterion number.

The network quality measuring method may include a step of calculating a number of times of a data loss, the data loss rate, and the data loss time which would be obtained when all the packets were obtained by carrying out n-degree differentiation to a difference between a confirmation response number of the confirmation response signal transmitted from the data transmission side and a certain criterion number.

The network quality measuring method may include a step of calculating a number of times of the data loss, the data loss rate, and the data loss time by determining that a data loss occurs when a value, which is obtained by carrying out first-degree differentiation to a difference between the confirmation response number and a certain criterion number or to a difference between the data transmission sequence and a certain criterion number, decreases.

The network quality measuring method may include a step of calculating a number of times of a data loss, the data loss rate, and the data loss time by determining that a data loss occurs when a value, which is obtained by carrying out second-degree differentiation to a difference between the confirmation response number and a certain criterion number or to a difference between the data transmission sequence and a certain criterion number is made negative.

According to the present invention, there is provided a method of measuring goodput which is characterized by including a step of sampling acknowledgement numbers by a sampling method for obtaining a number of samples smaller than that obtained by a complete sampling method and a step of calculating goodput based on the acknowledgement number sampled finally in a previous measurement period and the acknowledgement number sampled finally in a present measurement period.

According to the present invention, there is provided a method of measuring a number of times of a packet loss which is characterized by including a step of sampling acknowledgement numbers by a sampling method for obtaining a number of samples smaller than that obtained by a complete sampling method, and a step of determining a number of times in which the same acknowledgement number appears i times in a predetermined period as to all the “i”s equal to or larger than n and calculating a number of times of a packet loss by a statistical calculation based on the number of times.

According to the present invention, there is provided a method of measuring a number of times of a packet loss which is characterized by including a step of sampling acknowledgement numbers by a sampling method for obtaining a number of samples smaller than that obtained by a complete sampling method, and a step of calculating a number of times of the packet loss based on the acknowledgement numbers which are sampled and subjected to n-degree differentiation.

In the method of measuring a number of times of a packet loss, the value n may be any of 1, 2, or 3.

According to the present invention, there is provided a method of measuring goodput which is characterized by including a step of sampling sequence numbers by a sampling method of obtaining a number of samples smaller than that obtained by a complete sampling method, and a step of calculating goodput based on the sequence number sampled finally in a previous measurement period and the sequence number sampled finally in a present measurement period.

According to the present invention, there is provided a method of measuring a number of times of a packet loss which is characterized by including a step of sampling sequence numbers by a sampling method of obtaining a number of samples smaller than that obtained by a complete sampling method, and a step of calculating a number of times of the packet loss based on the sequence numbers which are sampled and subjected to n-degree differentiation.

In the method of measuring a number of times of a packet loss, the value n may any of 1, 2, or 3.

### EFFECT OF THE INVENTION

The present invention is a network quality measuring method of measuring quality of a network which is characterized by including a step of using the packets in a part of a certain period during which a reception confirmation signal is transmitted from a data reception side to a data transmission side as a target to be measured and calculating a number of times of a data loss, a data loss rate, a data loss time, and a data loss packet, which would be calculated when all the packets including the packets which cannot be measured in the certain period were obtained and calculated. Accordingly, even if a part of the packets are used as the target to be measured, the number of times of a data loss, the data loss rate, the data loss time, and the data loss packet can be accurately calculated.

### BRIEF DESCRIPTION OF THE DRAWINGS

FIG. 1 is a view showing an outline of a scope to which the technology is applied;

FIG. 2 shows a block diagram in Patent Document 1;

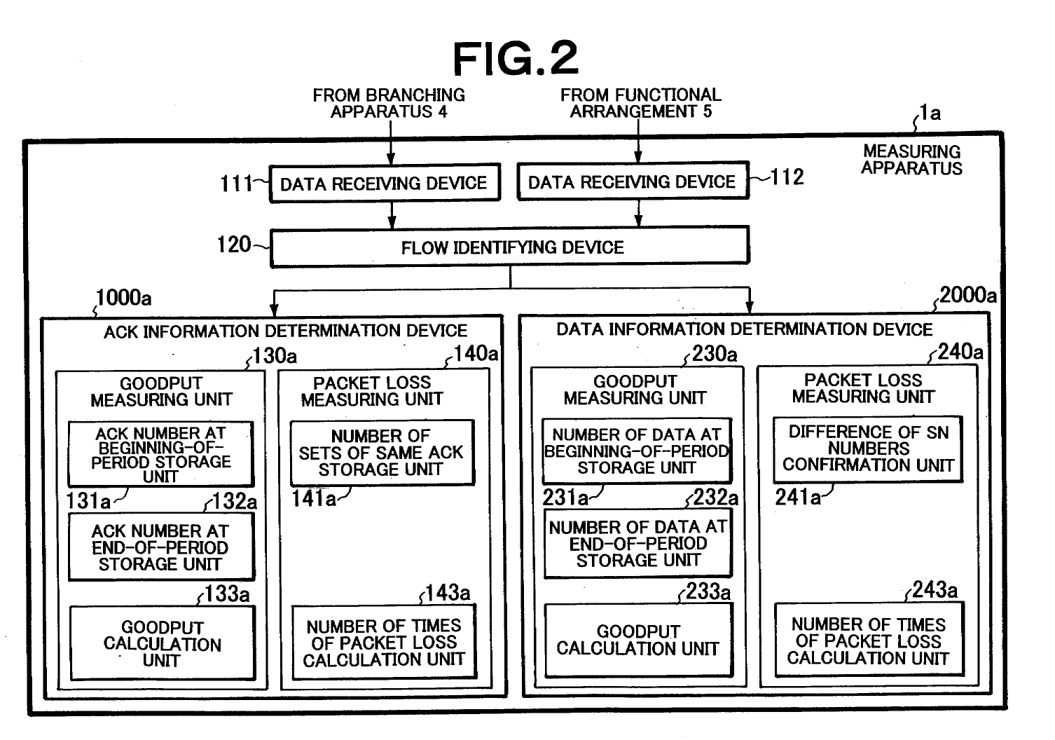

FIG. 3 is a view showing an outline of a process flow in Patent Document 1;

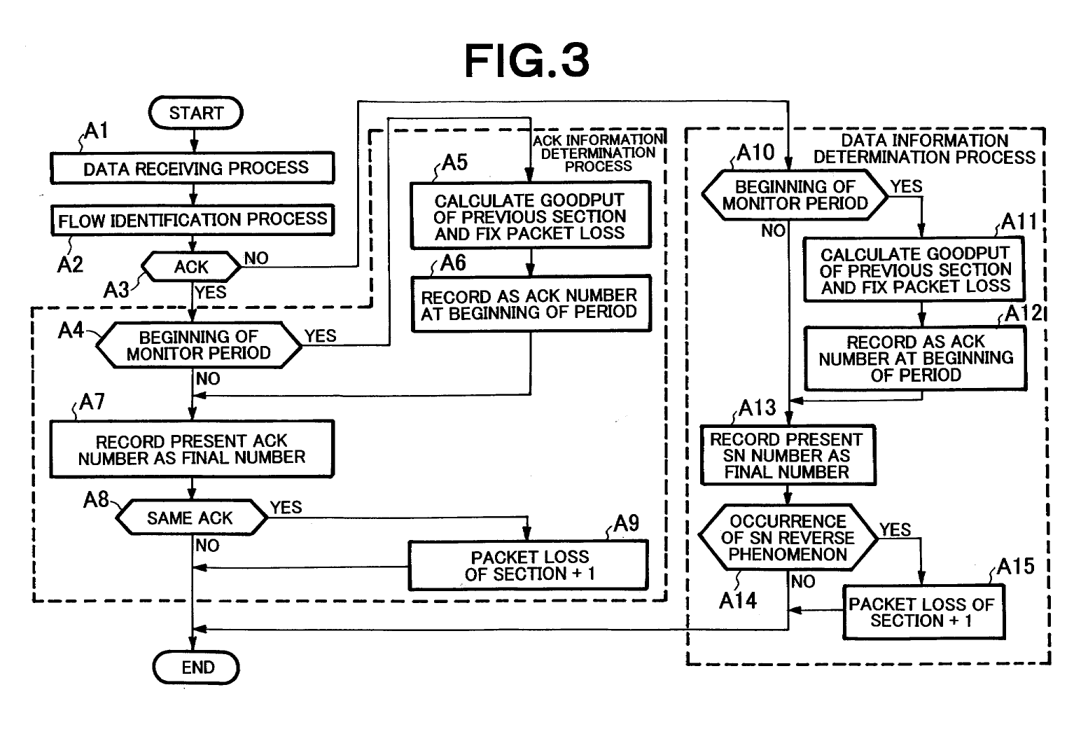

FIG. 4 is a block diagram of a measuring apparatus in a first embodiment;

FIG. 5 is a view showing an outline of a process flow in the measuring apparatus of the first embodiment;

FIG. 6 is a view showing an outline of a scope to which the technology is applied;

FIG. 7 is a view showing an outline of a scope to which the technology is applied;

FIG. 8 is a block diagram of a measuring apparatus in a second embodiment;

FIG. 9 is a view showing an outline of a process flow of the measuring apparatus of the second embodiment;

FIG. 10 is a block diagram of a measuring apparatus in a third embodiment;

FIG. 11 is a view showing an outline of a process flow of the measuring apparatus in the third embodiment;

FIG. 12 is a block diagram of a measuring apparatus in a fourth embodiment;

FIG. 13 is a view showing an outline of a process flow of the measuring apparatus in the fourth embodiment;

FIG. 14 is a block diagram of a measuring apparatus in a fifth embodiment; and

FIG. 15 is a view showing an outline of a process flow of the measuring apparatus in the fifth embodiment.

### REFERENCE NUMERALS

111 . . . data receiving device
112 . . . data receiving device
120 . . . flow identifying device
170 . . . sampling device
180 . . . ACK sampling rate estimation unit
190 . . . DATA sampling rate estimation unit
200 . . . quality determination device
210 . . . sampling rate decision device
1000b . . . ACK information determination device
1000c . . . ACK information determination device
1000e . . . ACK information determination device
2000d . . . DATA information determination device
2000e . . . DATA information determination device

### BEST MODE FOR CARRYING OUT THE INVENTION

A best mode for carrying out the invention will be explained below in detail with reference to the drawings.

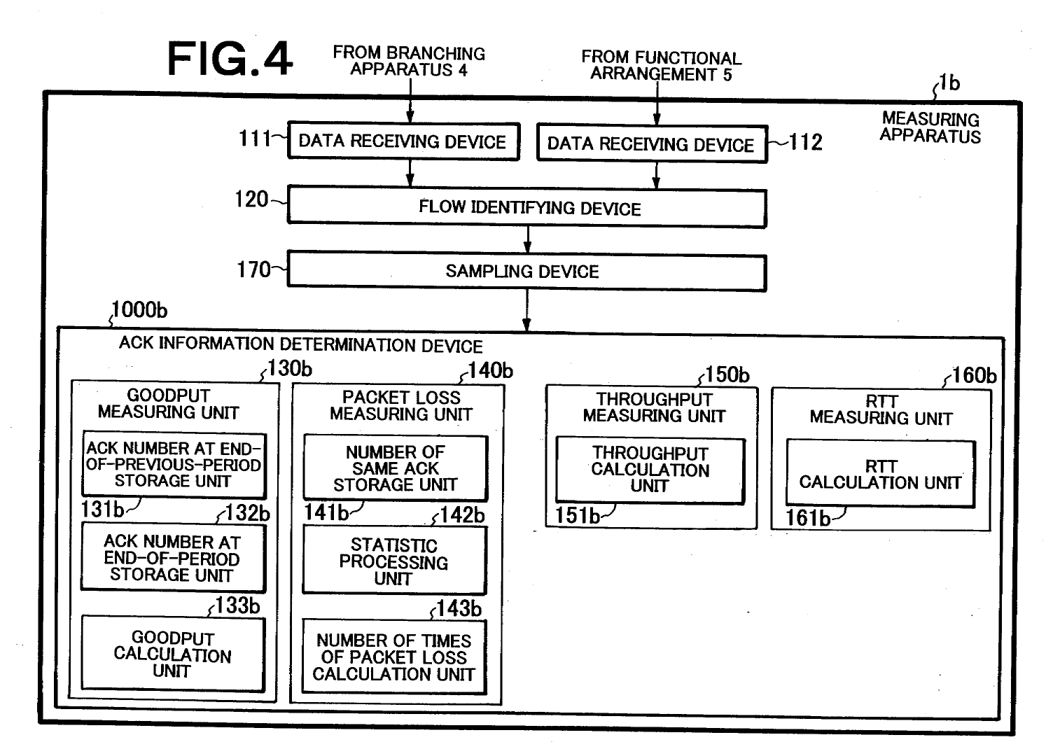

FIG. 4 is a block diagram showing an arrangement a first embodiment of a measuring apparatus 1b according to the present invention.

The measuring apparatus 1b of the first embodiment is composed of a data receiving device 111 to which data is input from a branching apparatus 4, a data receiving device 112 to which data is input from a branching apparatus 5, a flow identifying device 120 for identifying the input data of each flow, a sampling device 170 for sampling input packets, an ACK information determination device 1000b for measuring quality only from ACK side information, a goodput calculation unit 130b in the ACK information determination device 1000a, a storage unit 131b for storing the final ACK number in an immediately previous monitor period, a storage unit 132b for storing the final ACK number of a monitor period, a goodput calculation unit 133b for calculating goodput from the contents stored in the storage units 131b and 132b, a packet loss calculation unit 140b, a number of the number of same ACK storage unit 141b for counting a number of times of ACKs, a statistic processing unit 142b for estimating the number of sets of all the same ACKs with respect to the counted value using a statistic method, a number of times of packet loss calculation unit 143b for counting a number of times of packet losses, throughput calculation units 150b, 151b for calculating throughput from the goodput and packet losses, and RTT calculation units 160b, 161b for estimating Round Trip Time (hereinafter, abbreviated as RTT) from the throughput, the goodput, and the packet losses.

In the embodiment, a process is started by fetching data flowing on the network by the measuring apparatus 1b. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies a flow of the received data based on a received transmission/reception IP address, transmission/reception TCP port number, and protocol number. Quality of the network is measured for each flow. After the flow identifying process is carried out, the sampling device 170 subjects the input packets to sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. The sampling rate is notified to the goodput calculation unit 130b, the packet loss calculation unit 140b, the throughput measuring unit 150b, and the RTT measuring unit 160b when necessary.

When data to be processed is the ACK side information, the ACK information determination device 1000b carries out a process for measuring “throughput”, “goodput”, “packet loss”, and “RTT” in each predetermined monitor period.

To calculate goodput, the goodput calculation unit 130b updates a latest ACK number through the ACK number storage unit 132b each time it receives ACK. However, immediately after the monitor period is updated, the goodput calculation unit 133b carries out a goodput calculation process by calculating “the ACK number of the ACK number storage unit 132b—the ACK number of the ACK number storage unit 131b” before the value of the ACK number storage unit 132b is updated, and the final value of the ACK number storage unit 132b in a present period is substituted for the ACK number storage unit 131b in the end of a previous period to calculate goodput of a next monitor period.

To calculate the packet loss, the packet loss calculation unit 140b confirms whether or not at least n (arbitrary numeral) pieces of the same ACK numbers continuously appear in the number of same ACK storage unit 141b each time an ACK packet reaches. When the same ACK numbers continuously appear at least n times, the value of the number of same ACK storage unit 141b is incremented by 1. When the monitor period is updated, to calculate a result of packet loss of a previous monitor period, the statistic processing unit 142b estimates how many times ACK duplicating phenomena would originally occur when all the packets were sampled based on the number of times of duplication of the ACK numbers detected by the sampling using a statistic method. Then, the number of times of packet loss calculation unit 143b fixes the number of times of occurrence of the ACK duplicating phenomena as the number of times of the packet losses. After the process, the count of the number of same ACK storage unit 141b is reset to 0 to calculate the packet loss in a new monitor period.

To calculate throughput, the throughput measuring unit 150b calculates it based on the values of the goodput and the packet loss determined by the goodput calculation unit 130b and the packet loss calculation unit 140b. As a specific method of calculating throughput, “goodput/(1-packet loss rate)” is calculated. Here, the packet loss rate is calculated from a rate of goodput and packet loss.

To calculate RTT, the RTT measuring unit 160b calculates it based on the values of the goodput and the packet loss determined by the goodput calculation unit 130b and the packet loss calculation unit 140b.

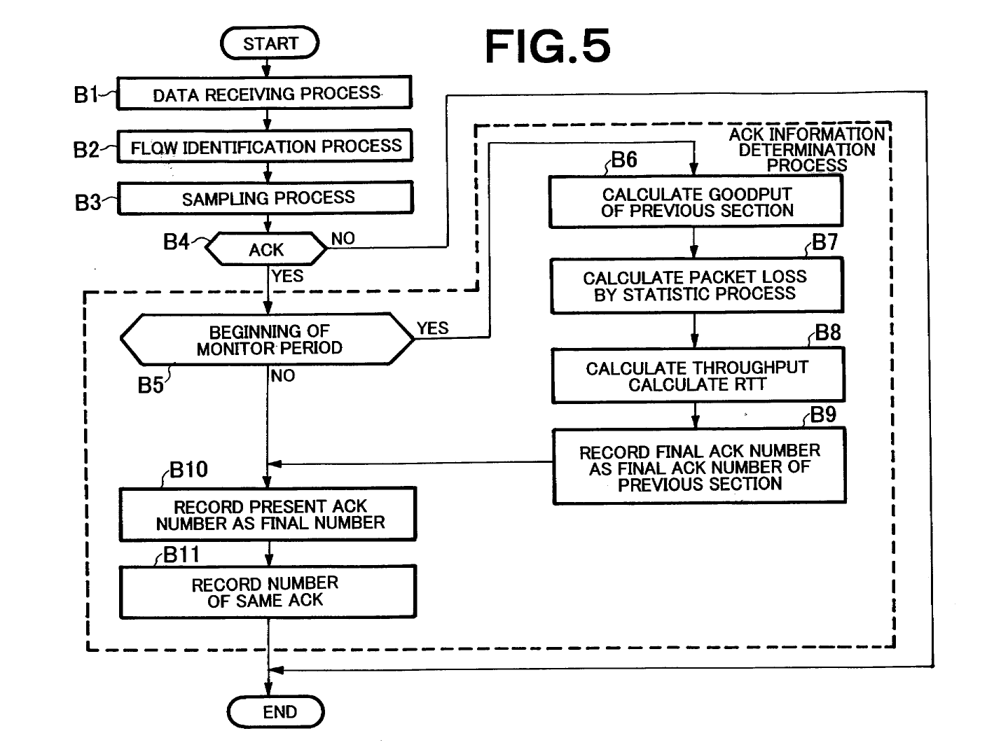

Next, measuring processes of quality of “throughput”, “goodput”, “packet loss”, and “RTT” carried out by the measuring apparatus 1b will be explained with reference to FIG. 5.

FIG. 5 shows an outline of a process flow in the measuring apparatus 1b.

The measuring apparatus 1b starts a process when data is input from the branching apparatus 4 or 5 and reaches the data receiving device 111 or 112. This process is a process B-1. After the completion of the process B-1, it goes to a process B-2.

The process B-2 is a process for identifying the same flow. The flow identifying device 120 identifies a flow of the received data based on a received transmission/reception IP address, transmission/reception TCP port number, and protocol number. The following processes are carried out in each flow. After the completion of the flow identifying process B-2, it goes to a process B-3.

The process B-3 is a packet sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. After the completion of the sampling process B-3, it goes to a process B-4.

In the process B-4, it is determined whether the input data has the ACK side information of the flow or the SN side information of the flow. When the input data has the ACK side information, the process B-4 goes to a process B-5. When the input data has the SN side information, the process is completed. Note that since TCP communication is arranged such that one data can include the ACK side information and the SN side information therein, ACK side information data of a flow may become SN side information data of other flow.

In the process B-5, it is confirmed whether or not a monitor section was updated from the time at which data was received last time. When the monitor section was updated, the process B-5 goes to a process B-6 to calculate a result of quality of a previous monitor section. When the monitor section was not updated, the process B-5 goes to a process B-10 to continuously monitor the quality of a present monitor section.

In the process B-6, a goodput measuring process of the previous monitor section is carried out. As a goodput measuring method, “the ACK number at end-of-period storage unit 132b—the ACK number at end-of-previous-period storage unit 131b” is calculated. After the completion of the process B-6, it goes to a process B-7.

In the process B-7, a packet loss of the previous monitor section is calculated. As a packet loss measuring method, the number of sets of the same ACKs, which were obtained when all the packets were sampled, is estimated by carrying out a statistic process in the statistic processing unit 142b based on the value of the number of same ACK storage unit 141b. The value is used as the number of times of the packet loss. After the completion of the process 8-7, it goes to a process B-8.

In the process B-8, a throughput calculation process and an RTT calculation process are carried out based on the values of the goodput and the packet loss determined in the processes B-6 and B-7. As a specific method of calculating throughput, “goodput/(1-packet loss rate)” is calculated. Here, the packet loss rate is calculated from a rate of goodput and packet loss. Further, RTT is calculated from goodput and a packet loss. After quality of the network of the previous monitor section is determined by these calculations, the process B-8 goes to a process B-9.

In the process B-9, the ACK number stored to the ACK number at end-of-period storage unit 132b until that time is substituted for the ACK number at end-of-previous-period storage unit 131b. Further, the count of the number of the same ACKs is reset to 0. After the completion of the process B-9, it goes to the process B-10.

In the process B-10, each time ACK is received, the number of the received ACK is stored to the ACK number at end-of-period storage unit 132b. After the completion of the process B-10, it goes to a process B-11.

In the process B-11, it is confirmed whether or not at least n (arbitrary numeral) pieces of the same ACK number continuously appears in the number of same ACK storage unit 141b. When the same ACK number continuously appears at least n times, the value of the number of same ACK storage unit 141b is incremented by 1. The process to the present packet is finished by the process B-11. Then, it is waited that next data is input.

The contents of the processes of the measuring apparatus 1b of the first embodiment according to the present invention are as described above.

As a method of calculating goodput in the conventional technology, a difference between the maximum ACK value and the minimum ACK value detected in a monitor period is calculated as goodput in the monitor period. Accordingly, when this calculation method is simply applied to the sampling measurement, a value calculated by the method is always smaller by initial and final data amounts thinned out by sampling in a monitor period. Further, as a method of calculating a packet loss, the number of sets of the same ACKs (the number of times in which the same ACK number appears at least three times) is counted as the packet loss. Accordingly, when this calculation method is simply applied to the sampling measurement, even if an ACK number continuously appears at least three times, a case in which the ACK number does not continuously appear due to sampling occurs many times. As a result, there is obtained the number of times of a packet loss which is greatly smaller than a proper value.

In contrast, in the embodiment, a difference between the ACK numbers finally detected in the respective monitor periods is calculated as goodput of the sections as a method of measuring goodput. Although a value of goodput is made larger or smaller than a proper value because ACK data is thinned out by the sampling, an average value of goodput of the embodiment shows a value approximately similar to a proper average value of goodput at all times. Further, as a method of measuring a packet loss, the proper number of the same ACKs is calculated as the packet loss from the number of sets of the same ACKs monitored by the sampling measurement using the statistic method. Accordingly, even if all the same ACKs cannot be detected by the sampling, it is possible to estimate a proper number of the same ACKs. Further, since approximately accurate values of goodput and a packet loss can be calculated even by the sampling, it is possible to calculate estimated values of throughput and RTT. As a result, quality can be correctly measured by using the above sampling method even if all the packets cannot be obtained. Further, since all the packets need not be processed to measure quality of a flow, it is not necessary to require a sophisticated calculation capability to a measuring apparatus.

In the embodiment, the apparatus for measuring quality of TCP communication is explained for the purpose of simplification. However, the present invention is a technology that is commonly applied to a case in which a sequence of a data train is described in transmission data and a retransmission scheme for defective data exists. Accordingly, the present invention generally covers protocol in which a retransmission mechanism such as HSTCP, SCTP, DCCP, and the like exists.

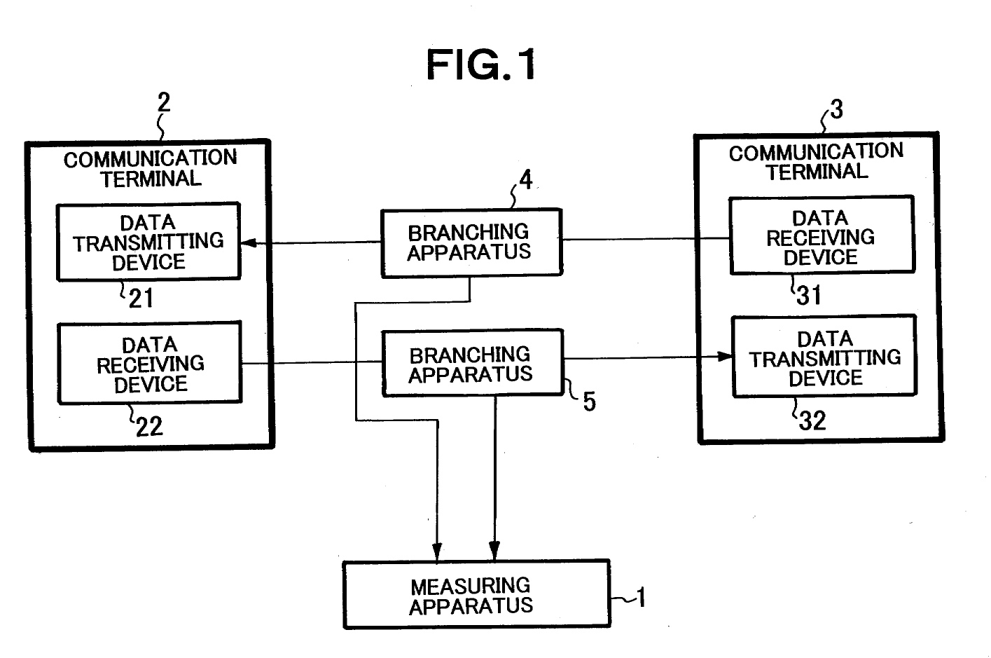

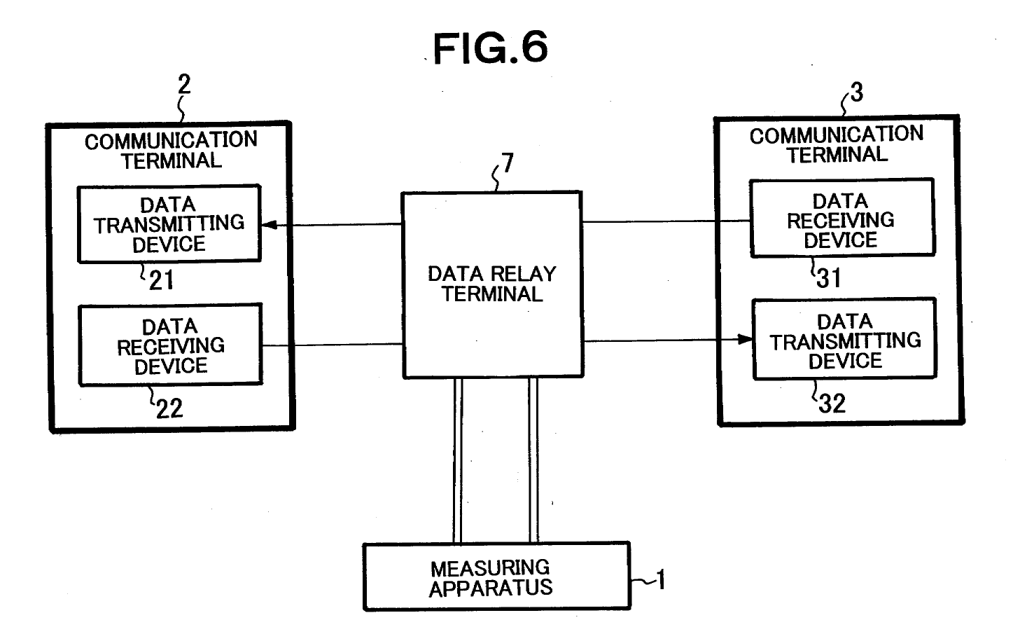

Further, the present invention can be applied not only to the state shown in FIG. 1 in which the measuring apparatus does not affect a network and a traffic which are not measured but also to the state shown in FIG. 6 in which the measuring apparatus is interposed between communication terminals and affect a network and a traffic which are not measured as long as data can be obtained. A data relay terminal in FIG. 6 includes an Ethernet (registered trademark) switch for transmitting data by a layer 2, a router for transmitting data by a layer 4, a gateway for transmitting data through a layer 4 or more, and the like, that is, a terminal for transmitting data as it is, a terminal for transmitting data by modifying protocol, and a terminal to which a load balance mechanism and a band control function are added.

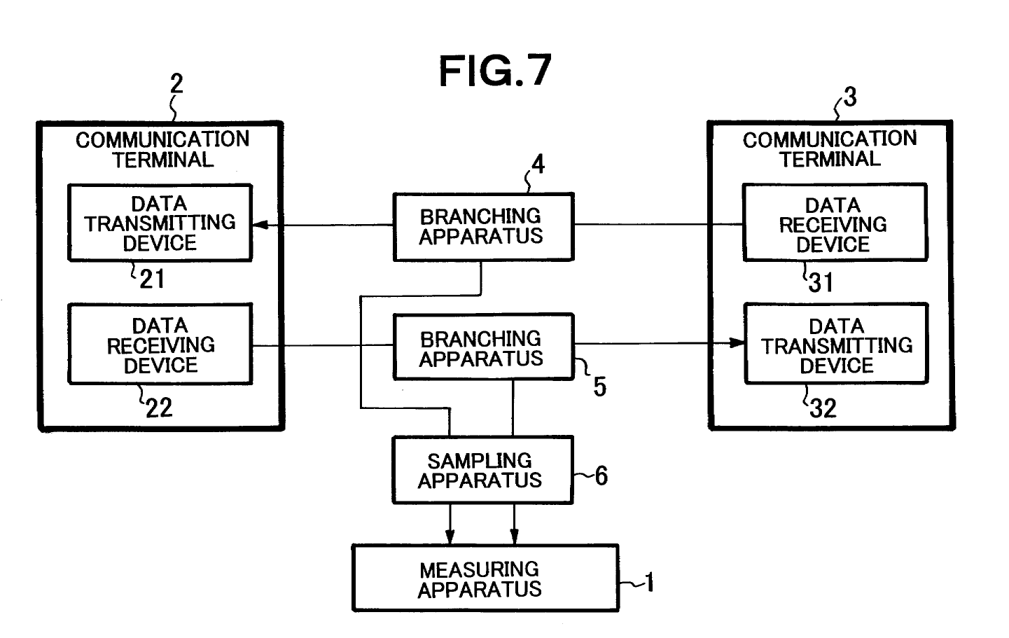

Further, the sampling processing portion may exist in any state as long as the measuring apparatus 1 can find a sampling rate in addition to a state in which it exists in the measuring apparatus 1 as in the embodiment. Specifically, the sampling processing portion shows a case in which the data relay terminal in the state of FIG. 6 includes a packet sampling function and a case in which a packet is input to the measuring apparatus 1 through a sampling apparatus 7 for a sampling process as shown in FIG. 7.

Further, although the sampling process 170 of the embodiment is carried out after the flow identifying process 120 is carried out, the same advantage can be exhibited even if the sampling process 170 is carried out before the flow identifying process 120 is carried out.

The statistic processing unit 142b and the process flow B-7 for calculating the packet loss estimate the proper number of sets of the same ACKs using the statistic method, and there is contemplated, as the contents of the estimation, a method of estimating the overall number of the same ACKs from a part of the detected number of the same ACKs assuming that the number of the same ACKs is generated according to a certain probability model.

As a calculation method of the estimation, there is a method of determining “overall number of the same ACKs=(value in which ACK number counted by the number of same ACK storage unit 141b continuously appears at least n times (n: arbitrary numeral)/(rate of certain probability distribution of at least n)”. The overall number of the same ACKs can be determined by calculating the above expression. Further, there is a case that values, in which a plurality of types of ACK numbers continuously appear, are stored, overall numbers of the same ACKs are estimated by the respective values, and an average value of the overall numbers is used as an overall number of the same ACKs (example: overall number of the same ACKs={(value in which ACK continuously appears at least n1 times/rate of certain probability distribution of at least n1)+(value in which ACK continuously appears at least n1 times/rate of certain probability distribution of at least n2)+ . . . (value in which ACK continuously appears at least nm times/rate of certain probability distribution of at least nm)}/m), and a case that a value obtained by subjecting the value of the above calculation to average weighting (example: overall number of the same ACKs={a1×(value in which ACK continuously appears at least n1 times/rate of certain probability distribution of at least n1)+a2×a1×(value in which ACK continuously appears at least n2 times/rate of certain probability distribution of at least n2)+ . . . am×(value in which ACK continuously appears at least nm times/rate of certain probability distribution of at least nm). Further, there is a case that the results of the above calculations are subjected to addition, subtraction, multiplication, and division.

Contemplated here as specific names of distribution are normal distribution, standard normal distribution, chi-square distribution, F-distribution, t-distribution, beta-distribution, exponential distribution, gamma distribution, binominal distribution, hypergeometrical distribution, exponential normal distribution, Poisson distribution, negative binominal distribution, Weibull distribution, regular distribution, and the like.

It is contemplated to determine parameters such as an average value, an average value, a dispersed value, and the like which are necessary to probability distribution from a past packet loss rate and a past sampling rate.

As one of calculation methods of the estimation, it is contemplated to estimate an overall number of the same ACKs by “numerical value in which an ACK number counted by the number of same ACK storage unit 141b appears continuously at least a predetermined times n (n: arbitrary number)/(1—probability of Poisson distribution 0—probability of Poisson distribution 1— . . . —probability of Poisson distribution n-1)” assuming that a number of the same ACKs can be shown according to Poisson distribution which has an average value determined based on a value inverse proportional to the route of a past packet loss rate and proportional to a sampling rate.

As a method of predicting the proper number of the same ACKs, there is contemplated to repeat a calculation for estimating an overall number of the same ACKs from a number of the same ACKs that can be detected in one monitor period a plurality of times. It can be expected to improve accuracy in the estimation of the number of the same ACKs by repeating the calculation. Specifically, in a first calculation, a parameter of a probability distribution is determined using a past packet loss rate or an arbitrary value, from which a number of the same ACKs and a packet loss rate in a present monitor period are estimated. Next, the parameter of the probability distribution is determined using the packet loss rate estimated in the first calculation, thereby a number of the same ACKs and a packet loss rate in the monitor period are estimated again. It is possible to improve the accuracy in the estimation of the packet loss rate by repeating the calculation.

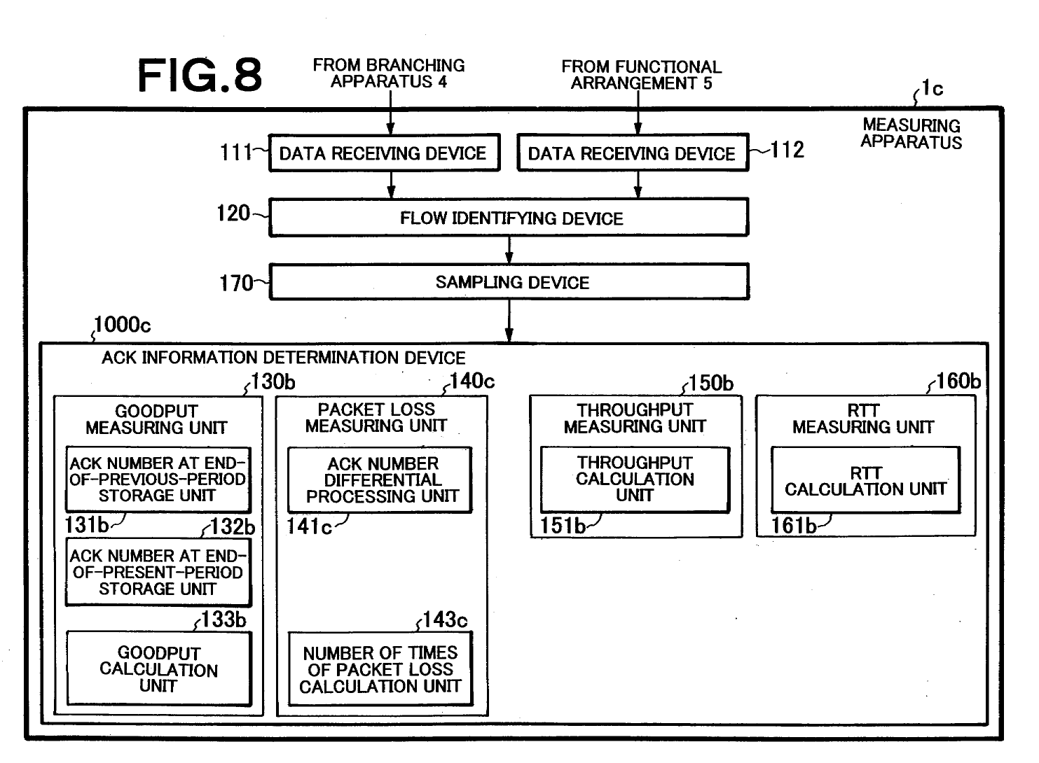

FIG. 8 is a block diagram showing an arrangement a second embodiment of a measuring apparatus 1c according to the present invention.

The measuring apparatus 1c of the second embodiment is composed of a data receiving device 111 to which data is input from a branching device 4, a data receiving device 112 to which data is input from a branching device 5, a flow identifying device 120 for identifying the input data of each flow, a sampling device 170 for sampling input packets, an ACK information determination device 1000c for measuring quality only from ACK side information, a goodput measuring unit 130a in the ACK information determination device 1000c, a storage unit 131b for storing the final ACK number in an immediately previous monitor period, a storage unit 132b for storing the final ACK number in a monitor period, a goodput calculation unit 133b for calculating goodput from the contents stored in the storage units 131b and 132b, a packet loss measuring unit 140c, an ACK number differential processing unit 141c for differentiating an ACK number with respect to a change of time, a number of times of packet loss calculation unit 143c for counting a number of times of packet losses, throughput calculation units 150b, 151b for calculating throughput from the goodput and the packet losses, and RTT calculation units 160b, 161b for estimating Round Trip Time (hereinafter, abbreviated as RTT) from the throughput, the goodput, and the packet losses.

In the embodiment, a process is started by fetching data flowing on the network by the measuring apparatus 1c. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies a flow of the received data based on a received transmission/reception IP address, transmission/reception TCP port number, and protocol number. Quality of the network is measured for each flow. After the flow identifying process is carried out, the sampling device 170 subjects the input packets to sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. The sampling rate is notified to the goodput calculation unit 130b, the packet loss calculation unit 140c, the throughput measuring unit 150b, and the RTT measuring unit 160b when necessary.

When data to be processed is the ACK side information, the ACK information determination device 1000c carries out a process for measuring “throughput”, “goodput”, “packet loss”, and “RTT” in each predetermined monitor period.

The goodput measuring process 130b of the second embodiment is the same as that of the first embodiment.

To measure a packet loss, the ACK number differential processing unit 141c of the packet loss measuring unit 140c differentiates an ACK number with respect to a change of time each time an ACK packet arrives. TCP continuously increases throughput ordinarily and decreases it when a packet loss occurs. When the ACK number is differentiated with respect to the change of time, an inclination increases until the packet loss occurs. When the packet loss occurs, the inclination is decreased by differentiating the ACK number with respect to the change of time. The packet loss is detected by the change of the inclination. The number of times of packet loss calculation unit 143c fixes the number of times in which the inclination decreases as the number of times of packet losses. Further, the count of the number of times of packet loss calculation unit 143c is initialized to 0 each time the monitor period is updated.

The goodput measuring process 150b of the second embodiment is the same as that of the first embodiment.

The RTT measuring process 130b of the second embodiment is the same as that of the first embodiment.

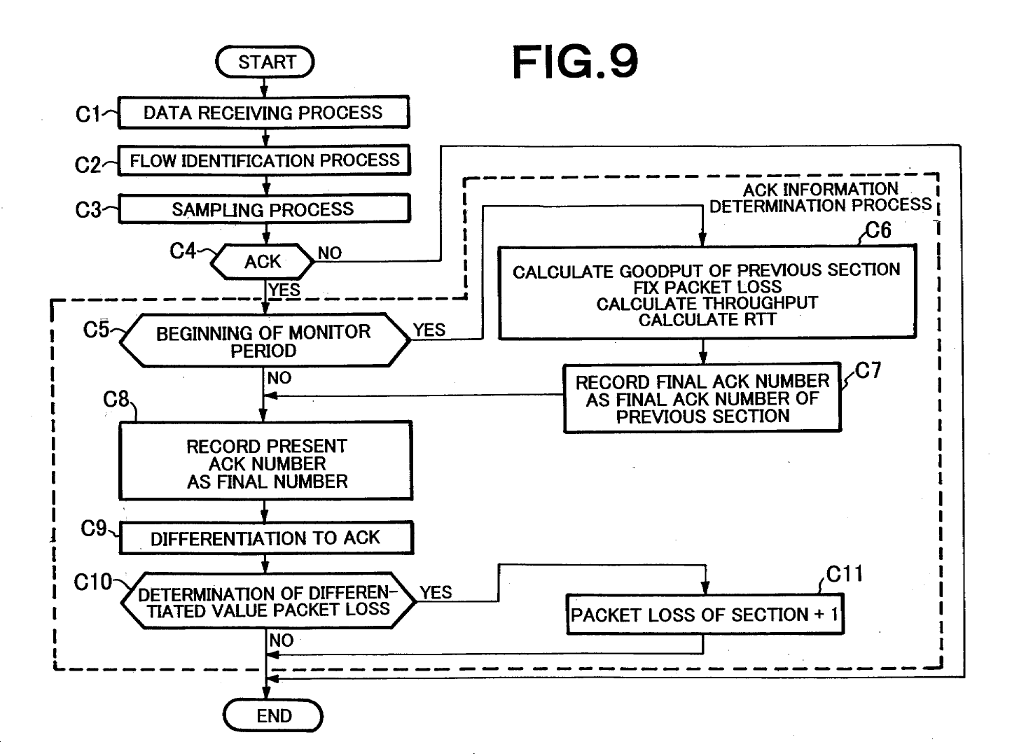

Next, measuring processes of quality of “throughput”, “goodput”, “packet loss”, and “RTT” carried out by the measuring apparatus 1c will be explained with reference to FIG. 9.

FIG. 9 shows an outline of a process flow in the measuring apparatus 1c.

The measuring apparatus 1c starts a process when data is input from the branching apparatus 4 or 5 and reaches the data receiving device 111 or 112. This process is a process C-1. After the completion of the process C-1, it goes to a process C-2.

The process C-2 is a process for identifying the same flow. The flow identifying device 120 identifies a flow of the received data based on a received transmission/reception IP address, transmission/reception TCP port number, and protocol number. The following processes are carried out in each flow. After the completion of the flow identifying process C-2, it goes to a process C-3.

The process C-3 is a packet sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. After the completion of the sampling process C-3, it goes to a process C-4.

In the process C-4, it is determined whether or not the input data has the ACK side information or the SN information of the flow. When the input data has the ACK side information, the process C-4 goes to a process C-5. When the input data has the SN side information, the process C-4 is completed. Note that since TCP communication is arranged such that one data can include the ACK side information and the SN side information therein, ACK side information data of a flow may become SN side information data of other flow.

In the process C-5, it is confirmed whether or not a monitor section was updated from the time at which data was received last time. When the monitor section was updated, the process C-5 goes to a process C-6 to calculate a result of quality of a previous monitor section. When the monitor section was not updated, the process C-5 goes to a process C-8 to continuously monitor the quality of a present monitor section.

In the process C-6, the quality of a network of the previous monitor section (throughput, goodput, packet loss, and RTT) is fixed. As a goodput measuring method, “the ACK number at end-of-period storage unit 132b—the ACK number at end-of-previous-period storage unit 131b” is calculated. As a packet loss calculating method, the value of the number of times of packet loss calculation unit 143c is fixed. As a specific method of calculating throughput, “goodput/(1-packet loss rate)” is calculated. Here, the packet loss rate is calculated from a rate of goodput and packet loss. Further, RTT is calculated from goodput and a packet loss. After quality of the network of the previous monitor section is determined by these calculations, the process C-6 goes to a process C-7.

In the process C-7, the ACK number stored to the ACK number at end-of-period storage unit 132b until that time is substituted for the ACK number at end-of-previous-period storage unit 131b. Further, the count of the number of times of packet loss calculation unit 143c is reset to 0. After the completion of the process C-7, it goes to the process C-8.

In the process C-8, each time ACK is received, the number of the received ACK is stored to the ACK number at end-of-period storage unit 132b. After the completion of the process C-8, it goes to a process C-9.

In the process C-9, the ACK number of the ACK obtained this time is subjected to a time differential process using certain ACK data as a reference. After the completion of the process C-9, it goes to a process C-10.

In the process C-10, whether or not a packet loss occurs is determined based on a result of the process C-9. When the inclination is greatly decreased as a result of the differential process, it is determined that the packet loss occurs, and the process C-10 goes to a process C-11. When the inclination is increased, it is determined that no packet loss occurs, and the processes to the present packet are finished. Then, it is waited that next data is input.

In the process C-11, it is determined that a packet loss is detected in the monitor section, and the count of the number of times of packet loss calculation unit 143c is incremented by 1. The processes to the present packet are finished by the above process. Then, it is waited that next data is input.

The contents of the processes of the measuring apparatus 1c of the second embodiment according to the present invention are as described above.

As a method of calculating goodput in the conventional technology, a difference between the maximum ACK value and the minimum ACK value detected in a monitor period is calculated as goodput in the monitor period. Accordingly, when this calculation method is simply applied to the sampling measurement, a value calculated by the method is always smaller by initial and final data amounts thinned out by sampling in a monitor period. Further, as a method of calculating a packet loss, the number of sets of the same ACKs (the number of times in which the same ACK number appears at least three times) is counted as the packet loss. Accordingly, when this calculation method is simply applied to the sampling measurement, even if an ACK number continuously appears at least three times, a case in which the ACK number does not continuously appear due to sampling occurs many times. As a result, there is obtained the number of times of a packet loss which is greatly smaller than a proper value.

In contrast, in the embodiment, a difference between the ACK numbers finally detected in the respective monitor periods is calculated as goodput of the sections as a method of calculating goodput. Although the value of goodput is made larger or smaller than a proper value because ACK data is thinned out by the sampling measurement, an average value of goodput of the embodiment shows a value approximately similar to a proper average value of goodput at all times. Further, as a method of measuring a packet loss, it is calculated by differentiating an ACK number monitored by the sampling and monitoring a change of the ACK number. Accordingly, even if all the ACKs cannot be obtained due to the sampling, the packet loss can be calculated. Further, since approximately accurate values of goodput and a packet loss can be calculated even by the sampling, it is possible to calculate estimated values of throughput and RTT. As a result, quality can be correctly measured by using the above sampling method even if all the packets cannot be obtained. Further, since all the packets need not be processed to measure quality of a flow, it is not necessary to require a sophisticated calculation capability to a measuring apparatus.

In the embodiment, the apparatus for measuring quality of TCP communication is explained for the purpose of simplification. However, the present invention is a technology that is commonly applied to a case in which a sequence of a data train is described in transmission data and a retransmission scheme for defective data exists. Accordingly, the present invention generally covers protocol in which a retransmission mechanism such as HSTCP, SCTP, DCCP, and the like exists.

Further, the present invention can be applied not only to the state shown in FIG. 1 in which the measuring apparatus does not affect a network and a traffic which are not measured but also to the state shown in FIG. 6 in which the measuring apparatus is interposed between communication terminals and affect a network and a traffic which are not measured as long as data can be obtained, A data relay terminal in FIG. 6 includes an Ethernet (registered trademark) switch for transmitting data by a layer 2, a router for transmitting data by a layer 4, a gateway for transmitting data through a layer 4 or more, and the like, that is, a terminal for transmitting data as it is, a terminal for transmitting data by modifying protocol, and a terminal to which a load balance mechanism and a band control function are added.

Further, the sampling processing portion is not limited to a case in which it exists in the measuring apparatus 1 as in the embodiment. Specifically, the sampling processing portion shows a case in which the data relay terminal of FIG. 6 includes a packet sampling function and a case in which a packet is input to the measuring apparatus 1 through a sampling apparatus 7 for a sampling process as shown in FIG. 7.

Further, although the sampling process 170 of the embodiment is carried out after the flow identifying process 120 is carried out, the same advantage can be exhibited even if the sampling process 170 is carried out before the flow identifying process 120 is carried out.

Further, although the ACK number differential processing unit 141c and the process flow C-9 carry out the differential process to ACK numbers, it is contemplated, as the contents of the process, to subject a difference between the ACK numbers to a time differential process each time ACK data is obtained. The differential process includes n-degree differentiation with respect to time such as second-degree differentiation, third-degree differentiation, and the like, in addition to first-degree differentiation.

Further, in the differential process to the ACK numbers, it is contemplated to change ACK data used as a reference to the process in each predetermined period such as each monitor period, each several minutes, each packet input, and the like.

As one of specific calculation methods of the differential process, it is contemplated to carry out a first-degree time differential process to a difference between ACK numbers using the final ACK data of a previous monitor period as a reference each time an ACK packet input. When an inclination decreases in the process, it is determined that a packet loss occurs. It is also contemplated to carry out second-degree differentiation with respect to time. In this case, when a negative value is detected, it is determined that the packet loss occurs. Further, at time, at which the packet loss occurs, and the range of the number of the packet loss can be found by investigating a time at which the value changes and a number of the value.

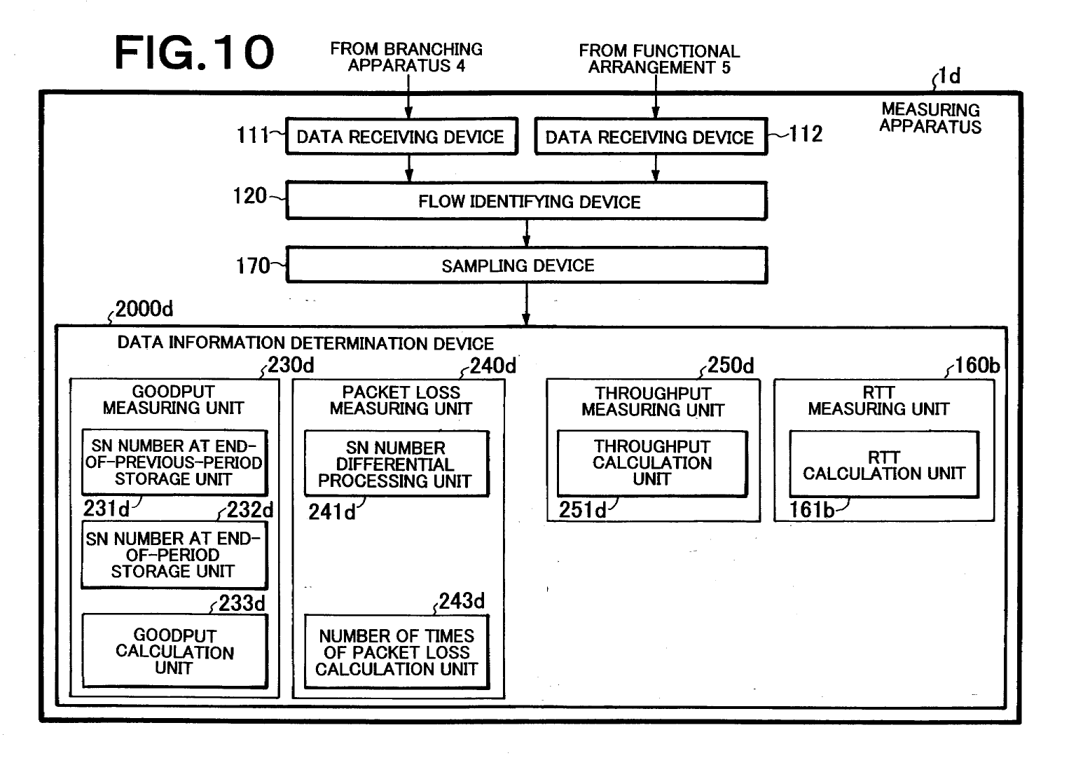

FIG. 10 is a block diagram showing an arrangement a third embodiment of a measuring apparatus 1d according to the present invention.

The measuring apparatus 1d of the third embodiment is composed of a data receiving device 111 to which data is input from a branching device 4, a data receiving device 112 to which data is input from a branching device 5, a flow identifying device 120 for identifying the input data of each flow, a sampling device 170 for sampling input packets, an SN information determination device 2000d for measuring quality only from SN side information, a goodput calculation unit 230d in the SN information determination device 2000d, a goodput calculating unit 230d in the SN information determination device 2000d, a storage unit 232a for storing the final SN number in an immediately previous monitor period, a storage unit 231d for storing the final SN number in a monitor period, a goodput calculation unit 233d for calculating goodput from the contents stored in the storage units 231d and 232d, a packet loss measuring unit 240d, an SN number differential processing unit 241d for differentiating an SN number with respect to a change of time, a number of times of packet losses calculation unit 243d for counting a number of times of packet losses, throughput calculation units 250d, 251d for calculating throughput from the goodput and the packet losses, and RTT calculation units 160b, 161b for estimating Round Trip Time (hereinafter, abbreviated as RTT) from the throughput, the goodput, and the packet losses.

In the embodiment, a process is started by fetching data flowing on the network by the measuring apparatus 1d. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies a flow of the received data based on a received transmission/reception IP address, transmission/reception TCP port number, and protocol number. Quality of the network is measured for each flow. After the flow identifying process is carried out, the sampling device 170 subjects the input packets to sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. The sampling rate is notified to the goodput calculation unit 230d, the packet loss calculation unit 240d, the throughput measuring unit 250d, and the RTT measuring unit 160b when necessary.

When data to be processed is SN side information, the SN information determination device 2000d carries out a process for measuring “throughput”, “goodput”, “packet loss”, and “RTT” in each predetermined monitor period.

To calculate goodput, the goodput calculation unit 230d updates a latest SN number through the SN number storage unit 232d each time it receives DATA. However, when the value of SN of this time is smaller than the maximum SN received in the past, it is not updated. Immediately after the monitor period is updated, the goodput calculation unit 233d carries out a goodput calculation process by calculating “the ACK number of the SN number storage unit 232d—the SN number of the SN number storage unit 231d” before the value of the SN number storage unit 232d is updated, and the final value of the SN number storage unit 232d in a present period is substituted for the SN number storage unit 231d in the end of a previous period to calculate goodput of a next monitor period.

To measure a packet loss, the packet loss measuring unit 240d differentiates an SN number with respect to a change of time through the SN number differential processing unit 241d each time a DATA packet arrives. TCP continuously increases throughput ordinarily and decreases it when a packet loss occurs. Accordingly, when the SN number is differentiated with respect to the change of time, an inclination increases until the packet loss occurs. When the SN number is differentiated with respect to the change of time at the time the packet loss occurs, the inclination decreases. The packet loss is detected by the change of the inclination. The number of times of packet losses calculation unit 243d fixes the number of times in which the inclination decreases as the number of times of packet losses. Further, the count of the number of times of packet losses calculation unit 243d is initialized to 0 each time the monitor period is updated.

To calculate throughput, the throughput calculation unit 250d calculates it based on the values of the goodput and the packet loss determined by the goodput measuring unit 230d and the packet loss measuring unit 240d. As a specific method of calculating throughput, “amount of goodput+amount of packet loss” is calculated.

The RTT measuring process 130b of the third embodiment is the same as those of the first and second embodiments.

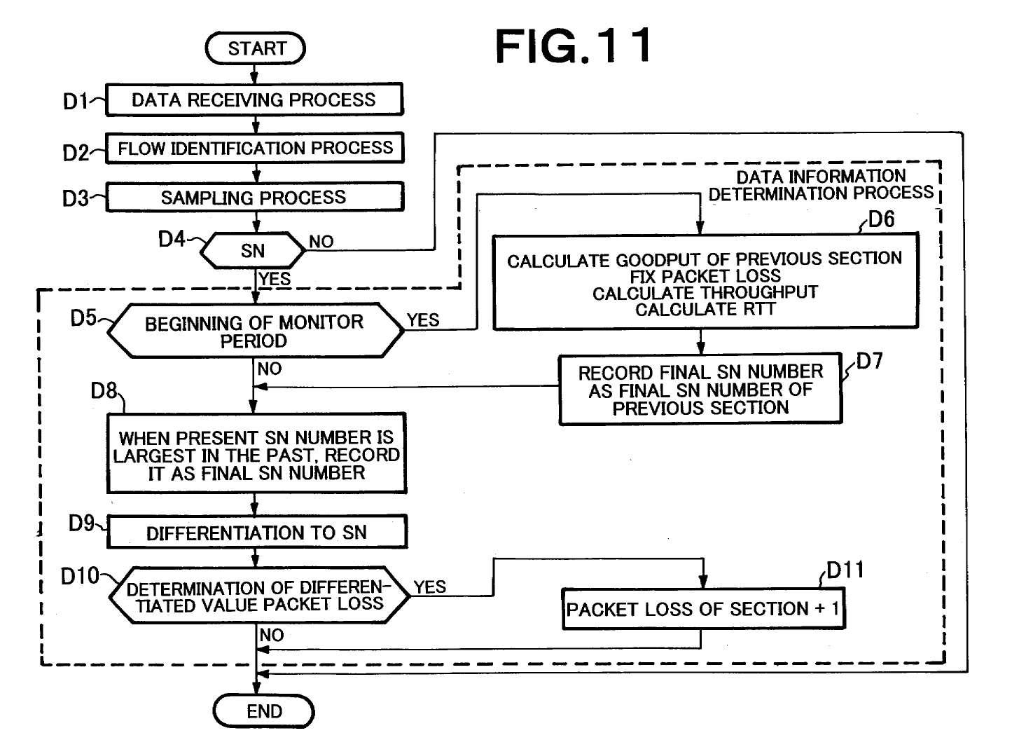

Next, measuring processes of quality of “throughput”, “goodput”, “packet loss”, and “RTT” carried out by the measuring apparatus 1d will be explained with reference to FIG. 11.

FIG. 11 shows an outline of a process flow in the measuring apparatus 1d.

The measuring apparatus 1d starts a process when data is input from the branching apparatus 4 or 5 and reaches the data receiving device 111 or 112. This process is a process D-1. After the completion of the process D-1, it goes to a process D-2.

The process D-2 is a process for identifying the same flow. The flow identifying device 120 carries out a flow identification process of the received data based on a received transmission/reception IP address, transmission/reception TCP port number, and protocol number. The following processes are carried out in each flow. After the completion of the process D-2, it goes to a process D-3.

The process D-3 is a packet sampling (thinning-out) process. A sampling method employed here includes a random sampling method of generating random numbers at a designated sampling rate or at a sampling rate smaller than it and determining packets to be sampled based on the value of the generated random numbers, a steady (equal) sampling method of steadily determining packets to be sampled at sampling intervals set according to a designated sampling rate, and the like. After the completion of the process D-3, it goes to a process D-4.

In the process D-4, it is determined whether the input data has SN side information or ACK side information of the flow. When the input data has the ACK side information, the process D-4 goes to a process D-5. When the input data has the SN side information, the process D-4 is completed. Note that since TCP communication is arranged such that one data can include the ACK side information and the SN side information therein, ACK side information data of a flow may become SN side information data of other flow.

In the process D-5, it is confirmed whether or not a monitor section was updated from the time at which data was received last time. When the monitor section was updated, the process goes to a process D-6 to calculate a result of quality of a previous monitor section. When the monitor section was not updated, the process D-5 goes to a process D-8 to continuously monitor the quality of a present monitor section.

In the process D-6, the quality of a network of the previous monitor section (throughput, goodput, packet loss, and RTT) is fixed. As a goodput measuring method, “the SN number at end-of-period storage unit 232d—the SN number at end-of-previous-period storage unit 231d” is calculated. As a method of calculating a packet loss, the value of the number of times of packet losses calculation unit 243d is fixed. As a specific method of calculating throughput, “amount of goodput+amount of packet loss” is calculated. Further, RTT is calculated from goodput and a packet loss. After quality of the network of the previous monitor section is determined by these calculations, the process D-6 goes to a process D-7.

In the process D-7, the SN number stored to the SN number at end-of-period storage unit 232d up to that time is substituted for the SN number at end-of-previous-period storage unit 231d. Further, the count of the number of times of packet losses calculation unit 243d is reset to 0. After the completion of the process D-7, it goes to a process D-8.

In the process D-8, each time SN is received, a received SN number is stored to the SN number at end-of-period storage unit 232d. However, when the value of SN of this time is smaller than the maximum SN received in the past, the storage process is not carried out. After the completion of the process D-8, it goes to a process D-9.

In the process D-9, the SN number of DATA obtained this time is subjected to a time differential process using certain DATA data as a reference. After the completion of the process D-9, it goes to a process D-10.

In the process D-10, whether or not a packet loss occurs is determined based on a result of the process D-9. When an inclination greatly decreases as a result of the differential process, it is determined that the packet loss occurs, and the process D-10 goes to a process D-11. When the inclination increases, it is determined that no packet loss occurs, and the process to the present packet is finished. Then, it is waited that next data is input.

In the process D-11, it is determined that a packet loss is detected in the monitor section, and the count of the number of times of packet losses calculation unit 243d is incremented by 1. The process to the present packet is finished by the above process. Then, it is waited that next data is input.

The contents of the processes of the measuring apparatus 1d of the third embodiment according to the present invention are as described above.

As a method of calculating goodput in the conventional technology, a difference between the maximum SN value and the minimum SN value detected in a monitor period is calculated as goodput in the monitor period. Accordingly, when this calculation method is simply applied to the sampling measurement, a value calculated by the method is always smaller by initial and final data amounts thinned out by sampling in a monitor period. Further, as a method of calculating a packet loss, the maximum SN received in the past in a monitor period is compared with the SN of the data received this time, and when the SN of this time is smaller than the maximum SN, it is determine that a packet loss occurs. Accordingly, when a portion in which SN is reversed is thinned out by simply applying the calculation method to the sampling measurement, a packet loss cannot be detected, and thus the number of times of occurrence of a packet loss is made smaller than the proper number of times.

In contrast, in the embodiment, a difference between the SN numbers finally detected in the respective monitor periods is calculated as goodput of the section as a method of measuring goodput. Although the value of goodput is made larger or smaller than a proper value because SN data is thinned out by the sampling measurement, an average value of goodput of the embodiment shows a value approximately similar to a proper average value of goodput at all times. Further, as a method of measuring a packet loss, it is calculated by differentiating an SN number monitored by the sampling measurement and monitoring a change of the SN number. Accordingly, even if all the SNs cannot be obtained due to sampling, the packet loss can be calculated. Further, since approximately accurate values of goodput and a packet loss can be calculated even by the sampling, it is possible to calculate estimated values of throughput and RTT. As a result, quality can be correctly measured by using the above sampling method even if all the packets cannot be obtained. Further, since all the packets need not be processed to measure quality of a flow, it is not necessary to require a sophisticated calculation capability to a measuring apparatus.

In the embodiment, the apparatus for measuring quality of TCP communication is explained for the purpose of simplification. However, the present invention is a technology that is commonly applied to a case in which a sequence of a data train is described in transmission data and a retransmission scheme for defective data exists. Accordingly, the present invention generally covers protocol in which a retransmission mechanism such as HSTCP, SCTP, DCCP, and the like exists.

Further, the present invention can be applied not only to the state shown in FIG. 1 in which the measuring apparatus does not affect a network and a traffic which are not measured but also to the state shown in FIG. 6 in which the measuring apparatus is interposed between communication terminals and affect a network and a traffic which are not measured as long as data can be obtained. A data relay terminal in FIG. 6 includes an Ethernet (registered trademark) switch for transmitting data by a layer 2, a router for transmitting data by a layer 4, a gateway for transmitting data through a layer 4 or more, and the like, that is, a terminal for transmitting data as it is, a terminal for transmitting data by modifying protocol, and a terminal to which a load balance mechanism and a band control function are added.

Further, the sampling processing portion is not limited to a case in which it exists in the measuring apparatus 1 as in the embodiment. Specifically, the sampling processing portion shows a case in which the data relay terminal of FIG. 6 includes a packet sampling function and a case in which a packet is input to the measuring apparatus 1 through a sampling apparatus 7 for the sampling process as shown in FIG. 7.

Further, although the sampling process 170 of the embodiment is carried out after the flow identifying process 120 is carried out, the same advantage can be exhibited even if the sampling process 170 is carried out before the flow identifying process 120 is carried out.

Further, although the SN number differential processing unit 241d and the process flow D-9 carry out the differential process to SN numbers, it is contemplated, as the contents of the process, to subject a difference between the SN numbers to a time differential process each time SN data is obtained. The differential process includes n-degree differentiation with respect to time such as second-degree differentiation, third-degree differentiation, and the like, in addition to first-degree differentiation.

Further, in the differential process to the SN numbers, it is contemplated to change SN data used as a reference to the process in each predetermined period such as each monitor period, each several minutes, each packet input, and the like.

As one of specific calculation methods of the differential process, it is contemplated to carry out a first-degree differential process to a difference between SN numbers using the final SN data of a previous monitor period as a reference each time an SN packet input. When an inclination decreases in the process, it is determined that a packet loss occurs. It is also contemplated to carry out second-degree differentiation with respect to time. In this case, when a negative value is detected, it is determined that a packet loss occurs. Further, a time, at which the packet loss occurs, and the range of the number of the packet loss can be found by investigating a time at which the value changes and the number at the time.

Further, the embodiment exemplifies a case in which a process is carried out only to the data having DATA side information, it is also contemplated to determine quality of a network using the first and second embodiments to the data having the ACK side information.

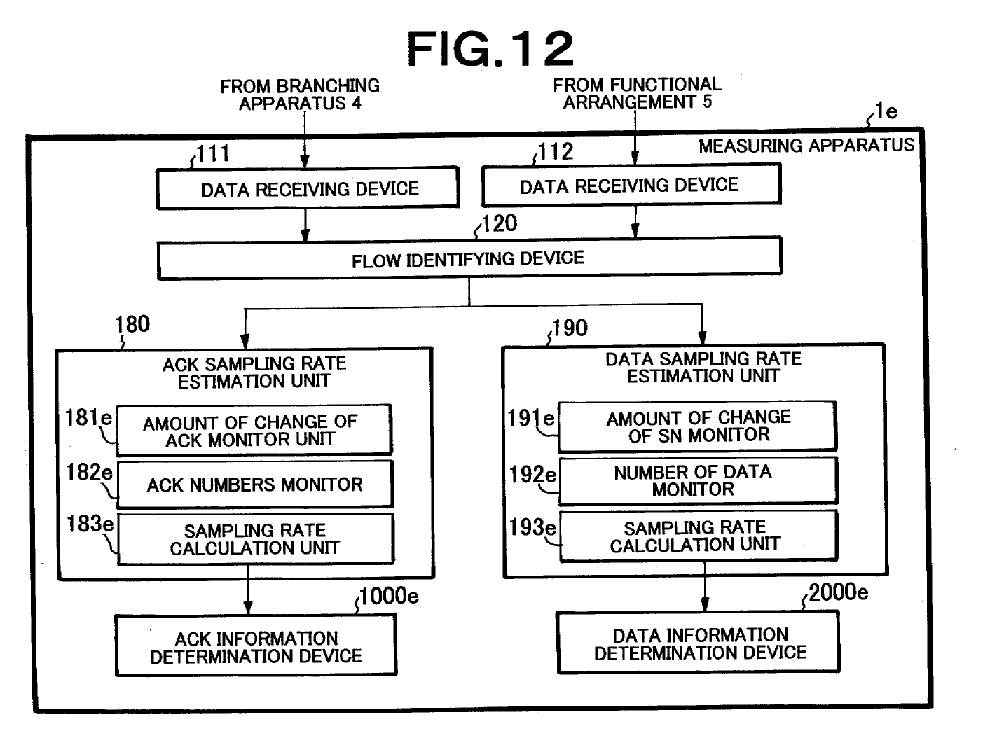

FIG. 12 is a block diagram showing an arrangement a fourth embodiment of a measuring apparatus 1e according to the present invention.

The measuring apparatus 1e of the fourth embodiment is composed of a data receiving device 111 to which data is input from a branching device 4, a data receiving device 112 to which data is input from a branching device 5, a flow identifying device 120 for identifying the input data of each flow, an ACK sampling rate estimation unit 180 for estimating a sampling rate of ACK data, an amount of change of ACK monitor 181e for monitoring an amount of change of ACK in a monitor period, a number of ACKs monitoring unit 182e, and a sampling rate calculation unit 183e in the ACK sampling rate estimation unit 180 each included in the ACK sampling rate estimation unit 180, a DATA sampling rate estimation unit 190 for estimating a sampling rate of DATA data, an amount of change of SN monitor 191e for monitoring an amount of change of SN in the monitor period, a number of SN monitor 192e, and a sampling rate calculation unit 193e each included in the DATA sampling rate estimation unit 190, an ACK information determination device 1000e for measuring quality of a network with respect to sampled ACK side information, and a DATA information determination device 2000e for measuring quality of the network with respect to sampled DATA side information.

In the embodiment, a process is started by fetching data flowing on the network by the measuring apparatus 1e. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies a flow of the received data based on a received transmission/reception IP address, transmission/reception TCP port number, and protocol number. Quality of the network is measured for each flow. After the flow identifying process is carried out, the ACK sampling rate estimation unit 180 processes ACK data, and the DATA sampling rate estimation unit 190 processes DATA data.

In the ACK sampling rate estimation unit 180, first, the amount of change of ACK monitor 181e records an amount of ACK numbers which change in respective monitor periods. It is contemplated that this is carried out by determining differences between the final ACK numbers in the respective monitor periods or by determining a difference between the initial and final ACK numbers of a monitor period. Next, the number of ACKs monitoring unit 182e monitors the number of ACKs received in the respective monitor periods. The value is counted in each monitor period. The sampling rate calculation unit 183e estimates a sampling rate using the values of the amount of change of ACK monitor 181e and the number of ACKs monitoring unit 182e. After the completion of the sampling rate estimation process, the ACK information determination device 1000e carries out a process for measuring the quality of the network. As a specific process of the measuring process, there can be employed the methods of the first and second embodiments and a method other than them.

In the DATA sampling rate estimation unit 190, first, the amount of change of SN monitor 191e records the amounts of SN numbers which change in the respective monitor periods. It is contemplated that this is carried out by determining a difference between the final SN numbers in the respective monitor periods or by determining a difference between the initial and final SN numbers of a monitor period. Next, the number of DATAs monitoring unit 192e monitors the number of SNs received in the respective monitor periods. The value is counted in each monitor period. The sampling rate calculation unit 193e estimates the sampling rate using the values of the amount of change of SN monitor 191e and the number of DATAs monitoring unit 192e. After the completion of the sampling rate estimation process, the DATA information determination device 2000e carries out a process for measuring the quality of the network. As a specific process of the measuring process, there can be employed the method of the third embodiment and a method other than it.

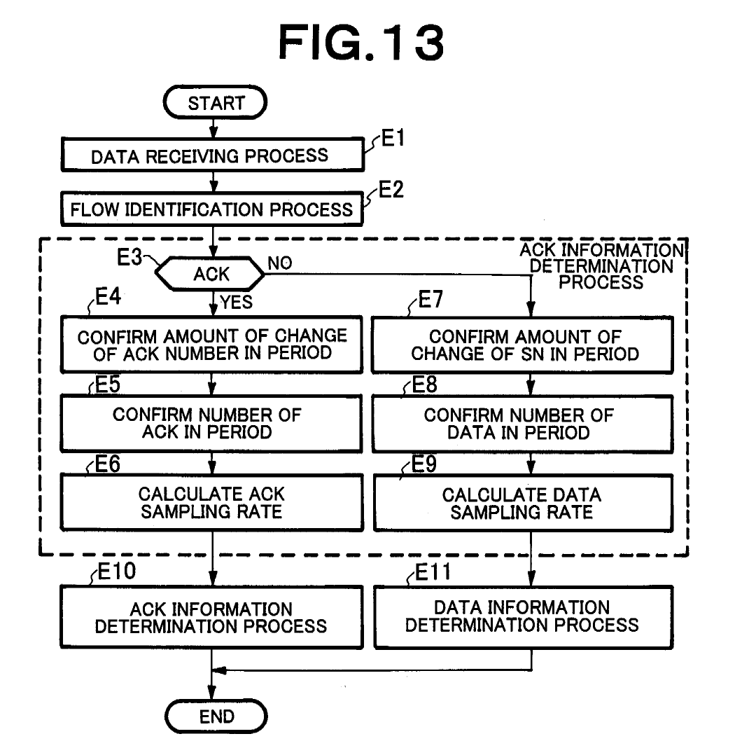

Next, measuring processes of quality of “throughput”, “goodput”, “packet loss”, and “RTT” carried out by the measuring apparatus 1e will be explained with reference to FIG. 13.

FIG. 13 shows an outline of a process flow in the measuring apparatus 1e.

Next, the measuring processes of the quality of “throughput”, “goodput”, “packet loss”, and “RTT” carried out by the measuring apparatus 1d will be explained with reference to FIG. 13.

FIG. 13 shows the outline of the process flow in the measuring apparatus 1e.

The measuring apparatus 1e starts a process when data is input from the branching apparatus 4 or 5 and reaches the data receiving device 111 or 112. This process is a process E-1. After the completion of the process E-1, it goes to a process E-2.

The process E-2 is a process for identifying the same flow. The flow identifying device 120 carries out a flow identification process of the received data based on a received transmission/reception IP address, transmission/reception TCP port number, and protocol number. The following processes are carried out in each flow. After the completion of the flow identifying process E-2, it goes to a process E-3.

In the process E-3, it is determined whether the input data has SN side information or ACK side information of the flow. When the input data has the SN side information, the process E-3 goes to a process E-7. When the input data has the ACK side information, the process C-3 goes to a process E-4. Note that since TCP communication is arranged such that one data can include the ACK side information and the SN side information therein, ACK side information data of a flow may become SN side information data of other flow.

In the process E-4, the amount of change of SN monitor 191e examines an amount of change of an ACK number in the monitor period. The value is updated in each monitor period. After the completion of the process E-4, it goes to a process E-5.

In the process E-5, the number of ACKs monitoring unit 182e confirms the number of ACKs received in the monitor period. The value is updated in each monitor period. After the completion of the process E-5, it goes to a process E-6.

In the process E-6, the sampling rate calculation unit 183e calculates an ACK side sampling rate from the values of the amount of change of SN monitoring unit 181e and the number of ACKs monitoring unit 182e each time the monitor period is updated. After the completion of the process E-6, it goes to a process E-10.

In the process E-7, the amount of change of SN monitor 191e examines an amount of change of an SN number in the monitor period. The value is updated in each monitor period. After the completion of the process E-7, it goes to a process E-8.

In the process E-8, the number of DATAs monitoring unit 192e confirms the number of DATA data received in the monitor period. The value is updated in each monitor period. After the completion of the process E-8, it goes to a process E-9.

In the process E-9, the sampling rate calculation unit 193e calculates a DATA side sampling rate from the values of the amount of change of SN monitoring unit 181e and the number of DATAs monitoring unit 182e each time the monitor period is updated. After the completion of the process E-9, it goes to a process E-11.

In the process E-10, an ACK information determination process for measuring the quality of the network from the ACK side information is carried out. As a specific process of the measuring process, there can be employed the methods of the first and second embodiments and a method other than them. After the completion of the process E-10, it is waited that a next packet is input.

In the process E-11, a DATA information determination process is carried out to measure quality of the network from the DATA side information. As a specific process of the measuring process, there can be employed the method of the third embodiment and a method other than it. After the completion of the process E-11, the processes for the packet are completed, and it is waited that a next packet is input.

The contents of the processes of the measuring apparatus 1e of the fourth embodiment according to the present invention are as described above.

The conventional technology has a problem in that the quality of a network cannot be measured unless all the packets are obtained by the data receiving devices 111 and 112.

In contrast, in the embodiment, since the sampling rate can be estimated in the ACK and DATA sampling rate estimation processes even if the data receiving devices 111 and 112 and an external sampling device 6 cannot obtain all the packets, it is possible to estimate quality of the network by the sampling measurement method.

In the embodiment, the apparatus for measuring quality of TCP communication is explained for the purpose of simplification. However, the present invention is a technology that is commonly applied to a case in which a sequence of a data train is described in transmission data and a retransmission scheme for defective data exists. Accordingly, the present invention generally covers protocol in which a retransmission mechanism such as HSTCP, SCTP, DCCP, and the like exists.

Further, the present invention can be applied not only to the state shown in FIG. 1 in which the measuring apparatus does not affect a network and a traffic which are not measured but also to the state shown in FIG. 6 in which the measuring apparatus is interposed between communication terminals and affect a network and a traffic which are not measured as long as data can be obtained. A data relay terminal in FIG. 6 includes an Ethernet (registered trademark) switch for transmitting data by a layer 2, a router for transmitting data by a layer 4, a gateway for transmitting data through a layer 4 or more, and the like, that is, a terminal for transmitting data as it is, a terminal for transmitting data by modifying protocol, and a terminal to which a load balance mechanism and a band control function are added.

Further, as a sampling rate estimating method on the ACK side, there is contemplated a method of estimating it by comparing the value of the proper number of ACKs which is estimated from the value of the amount of change of ACK monitoring unit 181e with the value actually detected by the number of ACKs monitoring unit 182e.

As a specific calculation method of the sampling rate estimating method on the ACK side, there are contemplated a method of calculating an expression “sampling rate=constant×(value of the number of ACKs monitoring unit 182e)/(the amount of change of ACK monitor 181e+average number of times of packet losses in a past monitor period x estimated number of the same ACKs that occur in one packet loss)”, and the like.

Further, as a sampling rate estimating method on the DATA side, there is contemplated a method of estimating it by comparing the value of the proper number of DATAs which is estimated from the value of the amount of change of SN monitor 191e with the value actually detected by the number of DATAs monitoring unit 192e.

As a specific calculation method of the method of estimating the sampling rate on the DATA side, there are contemplated a method of calculating the expression “sampling rate=constant×(value of the number of DATAs monitoring unit 192e)/(the amount of change of SN monitor 191e+average number of times of packet losses in past monitor period×constant), and the like.

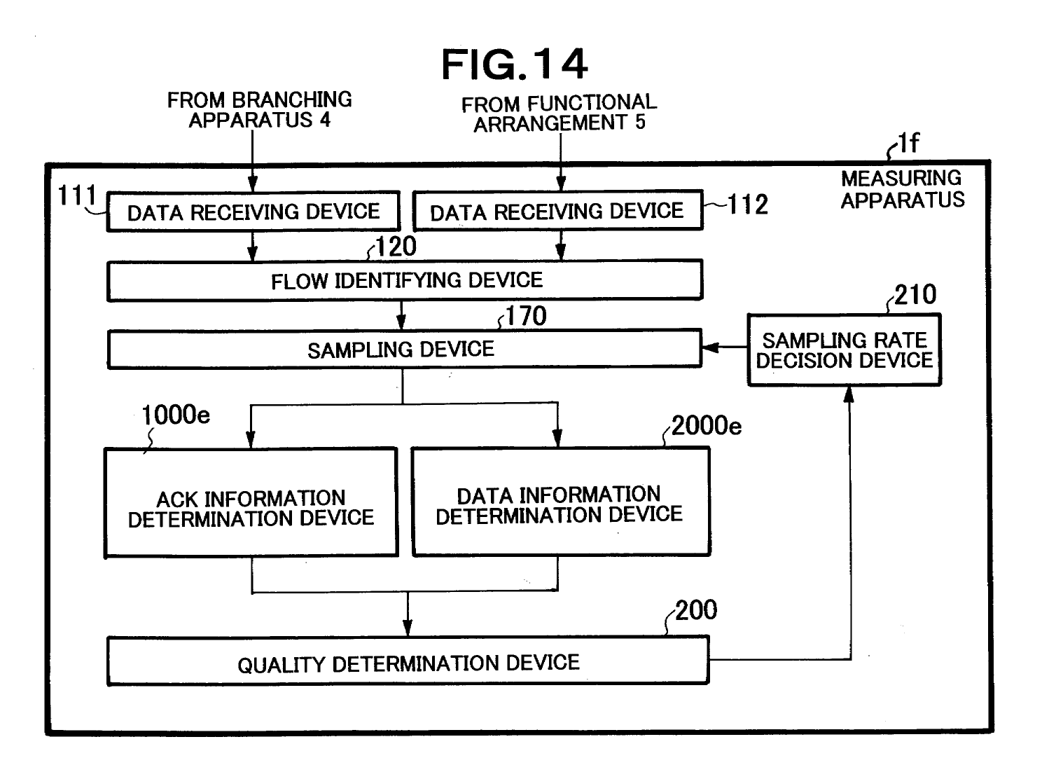

FIG. 14 is a block diagram showing an arrangement a fifth embodiment of a measuring apparatus 1f according to the present invention.

The measuring apparatus 1f of the fifth embodiment is composed of a data receiving device 111 to which data is input from a branching device 4, a data receiving device 112 to which data is input from a branching device 5, a flow identifying device 120 for identifying the input data of each flow, a sampling device 170 for sampling input packets, an ACK information determination device 1000e for measuring quality of a network with respect to sampled ACK side information, a DATA information determination device 2000e for measuring quality of the network with reference to sampled DATA side information, a quality determination device 200 for determining quality of each flow, and a sampling rate decision device 210 for deciding a sampling rate.

In the embodiment, a process is started by fetching data flowing on the network by the measuring apparatus 1f. The data input from the branching apparatus 4 is received by the data receiving device 111, and the data input from the branching apparatus 5 is received by the data receiving device 112. After the data is received by the data receiving devices 111 and 112, they deliver the data to the flow identifying device 120. The flow identifying device 120 identifies a flow of the received data based on a received transmission/reception IP address, transmission/reception TCP port number, and protocol number. Quality of the network is measured for each flow. After the flow identifying process is carried out, the sampling device 170 subjects the input packets to sampling (thinning-out) process. A sampling method employed here includes a random sampling method of generating random numbers within a sampling rate designated by the sampling rate decision unit 210 and determining packets to be sampled based on the value of the generated random numbers, a steady (equal) sampling method of steadily determining packets to be sampled at sampling intervals set according to the sampling rate designated by the sampling rate decision unit 210, and the like. The sampling rate is notified to the ACK information determination device 1000e and the DATA information determination device 2000e when necessary.

The ACK information determination device 1000e subjects ACK data to a network quality measuring process. As a specific process of the measuring process, there can be employed the methods of the first and second embodiments and a method other than them.

The DATA information determination device 2000e subjects DATA data to a network quality measuring process. As a specific process of the measuring process, there can be employed the method of the third embodiment and a method other than it.

After the ACK information determination device 1000e and the DATA information determination device 2000e calculate the quality of the network, the quality determination device 200 carries out a quality determination process. Quality is determined by a process of determining whether it is deteriorated or improved by comparing the values of throughput, goodput, a packet loss, and RTT or a value calculated by combining the values with a specific value used as a past history or a reference. A result of the determination is notified to the sampling rate decision device 210.

The sampling rate decision device 210 decides a sampling rate from a result of the determination of the quality determination device and process loads applied to the measuring apparatus 1f such as a rate of use of a CPU, the number of times of accesses to an HDD, an amount of use of a memory, an amount of power consumption, and the like.

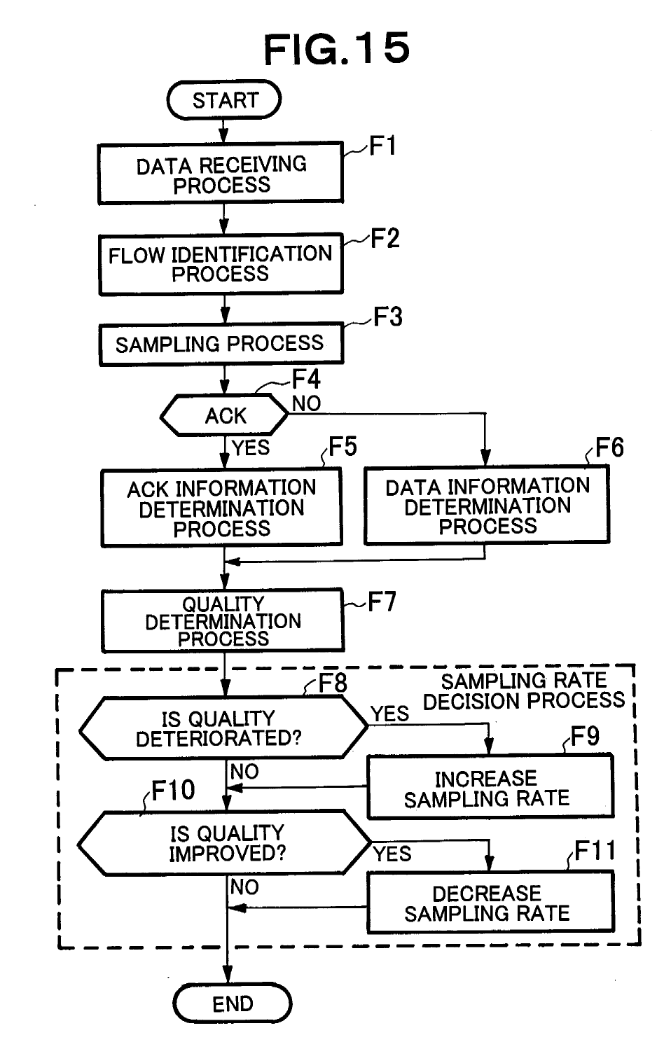

Next, measuring processes of quality of “throughput”, “goodput”, “packet loss”, and “RTT” carried out by the measuring apparatus 1f will be explained with reference to FIG. 15.

FIG. 15 shows an outline of a process flow in the measuring apparatus 1f.

The measuring apparatus 1f starts a process when data is input from the branching apparatus 4 or 5 and reaches the data receiving device 111 or 112. This process is a process F-1. After the completion of the process F-1, it goes to a process F-2.

The process F-2 is a process for identifying the same flow. The flow identifying device 120 identifies a flow of the received data based on a received transmission/reception IP address, transmission/reception TCP port number, and protocol number. The following processes are carried out in each flow. After the completion of the flow identifying process F-2, the process goes to a process F-3.

The process F-3 is a packet sampling (thinning-out) process. A sampling method employed here includes a random sampling method of generating random numbers within a sampling rate designated by the sampling rate decision unit 210 and determining packets to be sampled based on the value of the generated random numbers, a steady (equal) sampling method of steadily determining packets to be sampled at sampling intervals set according to the sampling rate designated by the sampling rate decision unit 210, and the like. After the completion of the sampling process, the process F-3 goes to a process F-4.

In the process F-4, it is determined whether the input data has SN side information or ACK side information of the flow. When the input data has the SN side information, the process F-4 goes to a process F-6. When the input data has the ACK side information, the process C-4 goes to a process F-5. Note that since TCP communication is arranged such that one data can include the ACK side information and the SN side information therein, ACK side information data of a flow may become SN side information data of other flow.

In the process F-5, an ACK information determination processing is carried out to measure quality of the network from the ACK side information. As a specific process of the measuring process, there can be employed the methods of the first and second embodiments, and a method other than them. After the completion of the processing, the process F-5 goes to a process F-7.

In the process F-6, a DATA information determination processing is carried out to measure quality of the network from the DATA side information. As a specific process of the measuring process, there can be employ the method of the third embodiment and a method other than it. After the completion of the process F-6, the process goes to the process F-7.

In the process F-7, a network quality determination process is carried out each time a monitor period is updated. Quality is determined by a process of determining whether it is deteriorated or improved by comparing the values of throughput, goodput, a packet loss, and RTT or a value calculated by combining the values with a specific value used as a past history or a criterion. After the completion of the process F-7, the process goes to a process F-8.

In the process F-8, whether or not the sampling rate is to be increased is determined from a result of determination in the process F-7 and the process loads applied to the measuring apparatus 1f. When it is determined that the sampling rate is to be increased, the process F-7 goes to a process F-9. When it is determined that the sampling rate is not to be increased, the process F-7 goes to a process F-10.

In the process F-9, a degree in which the sampling rate is changed is decided, and the sampling rate is reset. After the completion of the process F-9, it goes to the process F-10.

In the process F-10, whether or not the sampling rate is to be decreased from the result of determination in the process F-7 and the process loads applied to the measuring apparatus 1f. When it is determined that the sampling rate is to be decreased, the process F-10 goes to a process F-11. When it is determined that the sampling rate is not to be decreased, the process F-10 is completed, and a chance of next determination is waited.

In the process F-11, a degree in which the sampling rate is to be decreased is decided, and the sampling rate is reset. After the completion of the process F-11, a chance of next determination is waited.

The contents of the processes of the measuring apparatus 1f of the fifth embodiment according to the present invention are as described above.

In the conventional technology, even if there exist a flow, which need not be intensively monitored because its quality is sufficiently high, and a flow, which must be intensively monitored because its quality is low, since quality of a network cannot be measured unless all the packets are obtained, the same process load is required.

In contrast, in the embodiment, it is possible to change the sampling rate of each flow by decreasing the sampling rate of a flow which need not be intensively monitored because its quality is sufficiently high and increasing the sampling rate of a flow which must be intensively monitored because its quality is low. With this arrangement, it is possible to decrease a load applied to the measuring apparatus 1f while keeping accuracy necessary to monitoring.

In the embodiment, the apparatus for measuring quality of TCP communication is explained for the purpose of simplification. However, the present invention is a technology that is commonly applied to a case in which a sequence of a data train is described in transmission data and a retransmission scheme for defective data exists. Accordingly, the present invention generally covers protocol in which a retransmission mechanism such as HSTCP, SCTP, DCCP, and the like exists.

Further, the present invention can be applied not only to the state shown in FIG. 1 in which the measuring apparatus does not affect a network and a traffic which are not measured but also to the state shown in FIG. 6 in which the measuring apparatus is interposed between communication terminals and affect a network and a traffic which are not measured as long as data can be obtained. A data relay terminal in FIG. 6 includes an Ethernet (registered trademark) switch for transmitting data by a layer 2, a router for transmitting data by a layer 4, a gateway for transmitting data through a layer 4 or more, and the like, that is, a terminal for transmitting data as it is, a terminal for transmitting data by modifying protocol, and a terminal to which a load balance mechanism and a band control function are added.

Further, the sampling processing portion is not limited to a case in which it exists in the measuring apparatus 1 as in the embodiment. Specifically, the sampling processing portion shows a case in which the data relay terminal of FIG. 6 includes a packet sampling function and a case in which a packet is input to the measuring apparatus 1 through a sampling apparatus 7 for the sampling process as shown in FIG. 7.

Further, although the sampling processing 170 of the embodiment is carried out after the flow identifying process 120 is carried out, the same advantage can be exhibited even if the sampling process 170 is carried out before the flow identifying process 120 is carried out.

Contemplated as a criterion of the determination process of the quality determination device is a case in which throughput is made smaller than a past value by at least a predetermined rate, a case in which a packet loss is made larger that a past value by at least a predetermined rate, and a case in which RTT is made larger than a past value by at least a predetermined rate.

Contemplated as another criterion of the determination process of the quality determination device is a case in which throughput is made equal to or smaller than a predetermined value, a case in which goodput is made equal to or smaller than a predetermined value, a packet loss is made equal to or larger than a predetermined value, and RTT is made equal to or larger than a predetermined value.

When the sampling rate is shown by 1/N, it is contemplated, as a sampling rate decision process, to increase the value of N when quality is good and to decrease it when quality is bad. Further, it is also contemplated to increase the value of N when a heavy process load is applied to the measuring apparatus and to decrease it when a light process load is applied thereto.

Note that although the respective portions shown in FIGS. 4, 8, 10, 12, and 14 can be realized by hardware, they can be also realized by a computer by causing it to read a program for causing it to acts as the portions and causing it to carry out the program.

Further, although the respective processes shown in FIGS. 5, 9, 13, and 15 can be realized by hardware, they can be also realized by the computer by causing it to read a program for causing it to carry out the processes.

A first advantage of the embodiments resides in that it is possible to accurately estimate “packet loss” by the measuring apparatus even if all the ACK side packets cannot be obtained.

This is because when a present sampling rate and a probability distribution of the number of the same ACKs is found using a statistic method, the proper number of the same ACKs (which wound be found when all the ACKs were sampled) can be estimated from the partly detected number of the same ACKs. The number of the same ACKs is in intimate relation with a packet loss.

Another reason resides in that since data transmission in TCP has such a property that a data transmission speed is increased until a packet loss occurs and is decreased when a packet loss occurs, whether or not a packet loss occurs can be estimated by subjecting an ACK number to a differential process and confirming a change of the ACK number even if all the ACK side packets cannot be obtained.

Another advantage of the first advantage of the embodiments reside in that “packet loss” can be accurately estimated by the measuring apparatus even if a parameter of a probability distribution model is not known previously.

This is because even if the probability distribution model is created using an arbitrary parameter when a packet loss is estimated, an estimation accuracy of the packet loss can be improved by repeating a calculation for estimation.

A second advantage of the embodiments resides in that it is possible to accurately estimate “packet loss” by the measuring apparatus even if all the DATA side packets cannot be obtained.

This is because since data transmission in TCP has such a property that a data transmission speed is increased until a packet loss occurs and is decreased when a packet loss occurs, whether or not a packet loss occurs can be estimated by subjecting an SN number to a differential process and confirming a change of the SN number even if all the SN side packets cannot be obtained.

A third advantage of the embodiments resides in that it is possible to accurately estimate “goodput” by the measuring apparatus even if all the ACK side packets cannot be obtained.

This is because since differences between the final ACK numbers of the respective monitor periods are obtained and used as goodput in the monitor periods, even if ACK data which is not obtained by sampling exists, it is counted as an amount of communication in any of the monitor periods. As a result, average goodput has a value very near to true goodput (which is obtained when all the packets were sampled) at all times.

A fourth advantage of the embodiments resides in that it is possible to accurately estimate “goodput” by the measuring apparatus even if all the SN side packets cannot be obtained.

This is because since differences between the final SN numbers of the respective monitor periods are obtained and used as goodput of the monitor periods, even if SN data which is not obtained by sampling exists, it is counted as an amount of communication in any of the monitor periods when the data is not retransmitted data (which is larger than the past maximum SN). As a result, average goodput has a value very near to true goodput (which is obtained when all the packets were sampled) at all times.

A fifth advantage of the embodiments resides in that it is possible to accurately estimate “throughput by the measuring apparatus even if all the packets cannot be obtained.

This is because even if all the ACK side packets and all the SN side packets cannot be obtained, since goodput and a packet loss can be accurately estimated, throughput, which can be obtained by calculation from the goodput and the packet loss can be accurately calculated.

A sixth advantage of the embodiments resides in that it is possible to accurately estimate “RTT” by the measuring apparatus even if all the packets cannot be obtained.

This is because even if all the ACK side packets and all the SN side packets cannot be obtained, since goodput and a packet loss can be accurately estimated, the RTT, which can be obtained by calculation from the goodput and the packet loss, can be accurately calculated.

A seventh advantage of the embodiments resides in that it is possible to accurately measure quality of a network even if all the packets cannot be obtained.

This is because the quality of the network can be measured by the sampling measurement method.

An eighth advantage of the embodiments resides in that a sophisticated calculation capability is not required to a measuring apparatus.

This is because since the sampling measurement technology is used, it is not necessary to carry out a quality measurement calculation to all the packets flowing on a network line.

Further, this is because since the technology for estimating a sampling rate is used, it is not necessary to carry out sampling in the measuring apparatus and equipment relating to the apparatus.

Further, this is because since a sampling rate having an optimum accuracy required to monitoring can be set by deciding a sampling rate of each flow from the quality thereof, the number of packets to be obtained can be minimized at all times.

### INDUSTRIAL APPLICABILITY

The present invention can be used to measure communication quality of a network.

1-68. (canceled)

69. A network quality measuring method of measuring quality of a network, characterized by comprising:
a step of obtaining a number of times of appearance or reception confirmation numbers of a part of the same reception confirmation signals transmitted from a data reception side to a data transmission side and calculating at least any of a number of times of a data loss, a data loss rate, a data loss time, and a data loss packet based on the obtained result.

70. A network quality measuring method of measuring quality of a network, characterized by comprising:
a step of obtaining data transmission sequence numbers of a part of transmission data transmitted from a data transmission side to a data reception side and calculating at least any of a number of times of a data loss, a data loss rate, a data loss time, and a data loss packet based on the obtained result.

71. A network quality measuring method of measuring quality of a network, characterized by comprising:
a step of obtaining data transmission sequence numbers of a part of transmission data transmitted from a data transmission side to a data reception side and a number of times of appearance or reception confirmation numbers of a part of the same reception confirmation signals transmitted from the data reception side to the data transmission side and calculating at least a number of times of a data loss, a data loss rate, a data loss time, and a data loss packet based on the obtained result.

72. A network quality measuring method of measuring quality of a network according to claims 69, 70 or 71, characterized by comprising:
a step of obtaining a number of changes of the data transmission sequence of the transmission data transmitted from the data transmission side to the data reception side; a step of measuring the number of the transmission data; and
a step of calculating a sampling rate of packets from the number of changes of the data transmission sequence and the number of the transmission data.

73. A network quality measuring method of measuring quality of a network according to claims 69, 70 or 71, characterized by comprising:
a step of obtaining a number of changes of the data transmission sequence of the transmission data transmitted from the data transmission side to the data reception side;
a step of measuring the number of the transmission data; and
a step of calculating a sampling rate of packets from the number of changes of the data transmission sequence, the number of the transmission data, and a past data loss rate or the number of times of a past data loss.

74. A network quality measuring method of measuring quality of a network according to claims 69, 70 or 71, characterized by comprising:
a step of obtaining a number of changes of a confirmation response number of the confirmation response signal transmitted from the data reception side to the data transmission side;
a step of measuring the number of the confirmation response signal; and
a step of calculating a sampling rate of packets from the number of changes of the confirmation response number and a number of confirmation signals.

75. A network quality measuring method of measuring quality of a network according to claims 69, 70 or 71, characterized by comprising:
a step of obtaining a number of changes of a confirmation response number of the confirmation response signal transmitted from the data reception side to the data transmission side;
a step of measuring a number of the confirmation response signal; and
a step of calculating a sampling rate of packets from the number of changes of the confirmation response number, the number of the confirmation signal, and a past data loss rate or a number of times of a past data loss.

76. A network quality measuring method of measuring quality of a network according to claims 69, 70 or 71, characterized by comprising:
a step of obtaining packets sampled at a designated sampling rate.

77. A network quality measuring method of measuring quality of a network according to claims 69, 70, or 71, characterized by comprising:
a step of deciding a sampling rate using at least any one of the quality determined from a result of network quality and a load state of a measuring apparatus; and
a step of sampling packets obtained at the decided sampling rate.

78. A network quality measuring method of measuring quality of a network according to claim 125, characterized in that a probability distribution model is used at the step of calculating at least any of the number of times of appearance of the same confirmation response signals, the number of times of the data loss, and the data loss rate from the obtained number of times of appearance of the same confirmation response signals.

79. A network quality measuring method of measuring quality of a network according to claim 78, characterized in that at least any of normal distribution, standard normal distribution, chi-square distribution, F-distribution, t-distribution, beta-distribution, exponential distribution, gamma distribution, binominal distribution, hypergeometrical distribution, exponential normal distribution, Poisson distribution, negative binominal distribution, Weibull distribution, and regular distribution is used at the step of calculating at least any of the number of times of appearance of the same confirmation response signals, the number of times of the data loss, and the data loss rate from the obtained number of times of appearance the same confirmation response signals.

80. A network quality measuring method of measuring quality of a network according to claim 78 or 79, characterized in that at least any of the number of times of the data loss, the data loss rate, the sampling rate, a degree of the number of times of appearance of the same confirmation response signals determined and designated thereby, and goodput is used as a parameter at the step of calculating at least any of the number of times of appearance of the same confirmation response signals, the number of times of the data loss, and the data loss rate from the number of times of appearance the obtained same confirmation response signals.

81. A network quality measuring method of measuring quality of a network according to any one of claims 78 to 80, characterized in that a process for calculating a number of times of a packet loss from the calculated number of times of appearance of the same confirmation response signal is repeated a plurality of times as a step of calculating a number of times of appearance of the same confirmation response signals.

82. A network quality measuring method of measuring quality of a network according to any one of claims 78 to 80, characterized by comprising:
a step of calculating confirmation response signals, which would be calculated when all the packet were obtained, by predicting that a number of times in which the same confirmation response signals obtained by sampling appears at least an arbitrary number of times which corresponds to a probability having at least a certain value of the probability distribution model.

83. A network quality measuring method of measuring quality of a network according to claim 69, 70, 71, 72, 73, 74, 75, 76, or 77, characterized by comprising:
a step of calculating at least any of the number of times of the data loss, the data loss rate, the data loss time, and the data loss packet by carrying out n-degree differentiation to a difference between a data transmission sequence of the transmission data transmitted from the data transmission side to the data reception side and a certain criterion number.

84. A network quality measuring method of measuring quality of a network according to any one of claim 69, 70, 71, 72, 73, 74, 75, 76, or 77, characterized by comprising:
a step of calculating at least any of the number of times of the data loss, the data loss rate, the data loss time, and the data loss packet by carrying out n-degree differentiation to a difference between a confirmation response number of the confirmation response signal transmitted from the data reception side to the data transmission side and a certain criterion number.

85. A network quality measuring method of measuring quality of a network according to claim 83 or 84, characterized by comprising:
a step of calculating at least any one of the number of times of the data loss, the data loss rate, the data loss time, or the data loss packet by determining that a data loss occurs when a value, which is obtained by carrying out first-degree differentiation to the difference between the confirmation response number and the certain criterion number or to the difference between the data transmission sequence and a certain criterion number, decreases.

86. A network quality measuring method of measuring quality of a network according to claim 83 or 84, characterized by comprising:
a step of calculating at least any one of the number of times of the data loss, the data loss rate, the data loss time, or the data loss packet by determining that a data loss occurs when a value, which is obtained by carrying out second-degree differentiation to the difference between the confirmation response number and the certain criterion number or to the difference between the data transmission sequence and the certain criterion number is made negative.

87. A network quality measuring apparatus for measuring quality of a network, characterized by comprising:
means for obtaining a number of times of appearance or reception confirmation numbers of a part of the same reception confirmation signals transmitted from a data reception side to a data transmission side and calculating at least any of a number of times of a data loss, a data loss rate, a data loss time, and a data loss packet based on the obtained result.

88. A network quality measuring apparatus for measuring quality of a network, characterized by comprising:
means for obtaining data transmission sequence numbers of a part of transmission data transmitted from a data transmission side to a data reception side and calculating at least any of a number of times of a data loss, a data loss rate, a data loss time, and a data loss packet based on the obtained result.

89. A network quality measuring apparatus for measuring quality of a network, characterized by comprising:
means for obtaining data transmission sequence numbers of a part of transmission data transmitted from a data transmission side to a data reception side and a number of times of appearance or reception confirmation numbers of a part of the same reception confirmation signals transmitted from the data reception side to the data transmission side and calculating at least a number of times of a data loss, a data loss rate, a data loss time, and a data loss packet based on the obtained result.

90. A network quality measuring apparatus for measuring quality of a network according to claims 87, 88 or 89, characterized by comprising:
means for obtaining a number of changes of the data transmission sequence of the transmission data transmitted from the data transmission side to the data reception side; means for measuring the number of the transmission data; and
means for calculating a sampling rate of packets from the number of changes of the data transmission sequence and the number of the transmission data.

91. A network quality measuring apparatus for measuring quality of a network according to claims 87, 88 or 89, characterized by comprising:
means for obtaining a number of changes of the data transmission sequence of the transmission data transmitted from the data transmission side to the data reception side;
means for measuring the number of the transmission data; and
means for calculating a sampling rate of packets from the number of changes of the data transmission sequence, the number of the transmission data, and a past data loss rate or the number of times of a past data loss.

92. A network quality measuring apparatus for measuring quality of a network according to any one of claims 87, 88 or 89, characterized by comprising:
means for obtaining a number of changes of a confirmation response number of the confirmation response signal transmitted from the data reception side to the data transmission side;
means for measuring the number of the confirmation response signal; and
means for calculating a sampling rate of packets from the number of changes of the confirmation response number and a number of confirmation signals.

93. A network quality measuring apparatus for measuring quality of a network according to 87, 88 or 89, characterized by comprising:
means for obtaining a number of changes of a confirmation response number of the confirmation response signal transmitted from the data reception side to the data transmission side;
means for measuring a number of the confirmation response signal; and
means for calculating a sampling rate of packets from the number of changes of the confirmation response number, the number of the confirmation signal, and a past data loss rate or a number of times of a past data loss.

94. A network quality measuring apparatus for measuring quality of a network according to claims 87, 88 or 89, characterized by comprising:
means for obtaining packets sampled at a designated sampling rate.

95. A network quality measuring apparatus for measuring quality of a network according to claims 87, 88, or 89, characterized by comprising:
means for deciding a sampling rate using at least any one of the quality determined from a result of network quality and a load state of a measuring apparatus; and
means for sampling packets obtained at the decided sampling rate.

96. A network quality measuring apparatus for measuring quality of a network according to claim 87, 88, 89, 90, 91, 92, 93, 94, or 95, characterized in that a probability distribution model is used at the step of calculating at least any of the number of times of appearance of the same confirmation response signals, the number of times of the data loss, and the data loss rate from the obtained number of times of appearance of the same confirmation response signals.

97. A network quality measuring apparatus for measuring quality of a network according to claim 96, characterized in that at least any of normal distribution, standard normal distribution, chi-square distribution, F-distribution, t-distribution, beta-distribution, exponential distribution, gamma distribution, binominal distribution, hypergeometrical distribution, exponential normal distribution, Poisson distribution, negative binominal distribution, Weibull distribution, and regular distribution is used at the step of calculating at least any of the number of times of appearance of the same confirmation response signals, the number of times of the data loss, and the data loss rate from the obtained number of times of appearance the same confirmation response signals.

98. A network quality measuring apparatus for measuring quality of a network according to claim 96 or 97, characterized in that at least any of the number of times of the data loss, the data loss rate, the sampling rate, a degree of the number of times of appearance of the same confirmation response signals determined and designated thereby, and gooput is used as a parameter at the step of calculating at least any of the number of times of appearance of the same confirmation response signals, the number of times of the data loss, and the data loss rate from the number of times of appearance the obtained same confirmation response signals.

99. A network quality measuring apparatus for measuring quality of a network according to any one of claims 96 to 98, characterized in that a process for calculating a number of times of a packet loss from the calculated number of times of appearance of the same confirmation response signal is repeated a plurality of times as means for calculating a number of times of appearance of the same confirmation response signals.

100. A network quality measuring apparatus for measuring quality of a network according to any one of claims 96 to 98, characterized by comprising:
means for calculating confirmation response signals, which would be calculated when all the packet were obtained, by predicting that a number of times in which the same confirmation response signals obtained by sampling appears at least an arbitrary number of times which corresponds to a probability having at least a certain value of the probability distribution model.

101. A network quality measuring apparatus for measuring quality of a network according to claim 87, 88, 89, 90, 91, 92, 93, 94, or 95, characterized by comprising:
means for calculating at least any of the number of times of the data loss, the data loss rate, the data loss time, and the data loss packet by carrying out n-degree differentiation to a difference between a data transmission sequence of the transmission data transmitted from the data transmission side to the data reception side and a certain criterion number.

102. A network quality measuring apparatus for measuring quality of a network according to any one of claim 87, 88, 89, 90, 91, 92, 93, 94, or 95, characterized by comprising:
means for calculating at least any of the number of times of the data loss, the data loss rate, the data loss time, and the data loss packet by carrying out n-degree differentiation to a difference between a confirmation response number of the confirmation response signal transmitted from the data reception side to the data transmission side and a certain criterion number.

103. A network quality measuring apparatus for measuring quality of a network according to claim 101 or 102, characterized by comprising:
means for calculating at least any one of the number of times of the data loss, the data loss rate, the data loss time, or the data loss packet by determining that a data loss occurs when a value, which is obtained by carrying out first-degree differentiation to the difference between the confirmation response number and the certain criterion number or to the difference between the data transmission sequence and a certain criterion number, decreases.

104. A network quality measuring apparatus for measuring quality of a network according to claim 101 or 102, characterized by comprising:
means for calculating at least any one of the number of times of the data loss, the data loss rate, the data loss time, or the data loss packet by determining that a data loss occurs when a value, which is obtained by carrying out second-degree differentiation to the difference between the confirmation response number and the certain criterion number or to the difference between the data transmission sequence and the certain criterion number is made negative.

105. A program for causing a computer to carry out a network quality measuring method according to claims 69, 70, 71, 72, 73, 74, 75, 76, 77, 78, 79, 80, 81, 82, 83, 84, 85, 86 or 125.

106. A recording medium on which a program according to claim 105 is recorded and which can be read by the computer.

107. A method of measuring goodput, characterized by comprising:
a step of sampling confirmation response numbers by a sampling method of obtaining a number of samples smaller than that obtained by a complete sampling method; and
a step of calculating goodput based on the final and initial confirmation response numbers of a target to be measured.

108. A method of measuring a number of times of a packet loss or a packet loss rate, characterized by comprising:
a step of sampling confirmation response numbers by a sampling method of obtaining a number of samples smaller than that obtained by a complete sampling method; and
a step of determining a number of times in which the same confirmation response number appears i times or more in a predetermined period as to all the “i”s equal to or larger than n and calculating the number of times of the packet loss or the packet loss rate based on the number of times.

109. A method of measuring a number of times of a packet loss or a packet loss rate, characterized by comprising:
a step of sampling confirmation response numbers by a sampling method of obtaining a number of samples smaller than that obtained by a complete sampling method; and
a step of calculating the number of times of the packet loss based on the confirmation response numbers which are sampled and subjected to n-degree differentiation.

110. A method of measuring a number of times of a packet loss or a packet loss rate according to claim 108 or 109, characterized in that the value n is any of 1, 2, or 3.

111. A method of measuring goodput, characterized by comprising:
a step of sampling transmission sequence numbers by a sampling method of obtaining a number of samples smaller than that obtained by a complete sampling method; and
a step of calculating goodput based on the final and initial transmission sequence numbers of a target to be measured.

112. A method of measuring a number of times of a packet loss or a packet loss rate, characterized by comprising:
a step of sampling transmission sequence numbers by a sampling method of obtaining a number of samples smaller than that obtained by a complete sampling method; and
a step of calculating the number of times of the packet loss based on the transmission sequence numbers which are sampled and subjected to n-degree differentiation.

113. A method of measuring a number of times of a packet loss or a packet loss rate according to claim 112, characterized in that the value n is any of 1, 2, or 3.

114. A measuring apparatus of goodput, characterized by comprising:
means for sampling confirmation response numbers by a sampling method of obtaining a number of samples smaller than that obtained by a complete sampling method; and
means for calculating goodput based on the final and initial confirmation response numbers of a target to be measured.

115. A measuring apparatus of a number of times of a packet loss or a packet loss rate, characterized by comprising:
means for sampling confirmation response numbers by a sampling method of obtaining a number of samples smaller than that obtained by a complete sampling method; and
means for determining a number of times in which the same confirmation response number appears i times or more in a predetermined period as to all the “i”s equal to or larger than n and calculating the number of times of the packet loss or the packet loss rate based on the number of times.

116. A measuring apparatus of a number of times of a packet loss or a packet loss rate, characterized by comprising:
means for sampling confirmation response numbers by a sampling method of obtaining a number of samples smaller than that obtained by a complete sampling method; and
means for calculating the number of times of the packet loss based on the confirmation response numbers which are sampled and subjected to n-degree differentiation.

117. A measuring apparatus of a number of times of a packet loss or a packet loss rate according to claim 115 or 116, characterized in that the value n is any of 1, 2, or 3.

118. A measuring apparatus of goodput, characterized by comprising:
means for sampling transmission sequence numbers by a sampling method of obtaining a number of samples smaller than that obtained by a complete sampling method; and
means for calculating goodput based on the final and initial transmission sequence numbers of a target to be measured.

119. A measuring apparatus of a number of times of a packet loss or a packet loss rate, characterized by comprising:
means for sampling transmission sequence numbers by a sampling method of obtaining a number of samples smaller than that obtained by a complete sampling method; and
means for calculating the number of times of the packet loss based on the transmission sequence numbers which are sampled and subjected to n-degree differentiation.

120. A measuring apparatus of a number of times of a packet loss or a packet loss rate according to claim 119, characterized in that the value n is any of 1, 2, or 3.

121. A program for causing a computer to carry out a goodput measuring method according to claim 107 or 111.

122. A recording medium on which a program according to claim 121 is recorded and which can be read by the computer.

123. A program for causing a computer to carry out a method of measuring a number of times of a packet loss or a packet loss rate according to claim 108, 109, 110, 112, or 113.

124. A recording medium on which a program according to claim 123 is recorded and which can be read by a computer.

125. A method of measuring network quality according to claim 69, 70, 71, 72, 73, 74, 75, 76, or 77, characterized by comprising:
a step of obtaining a number of times in which the obtained same confirmation response signals appear at least a designated number of times n; and
a step of calculate at least any of a number of times in which the same confirmation response signals appear, a number of times of a data loss, or a data loss rate based on the obtained number of times.

126. An measuring apparatus of network quality according to claim 87, 88, 89, 90, 91, 92, 93, 94, or 95, characterized by comprising:
means for obtaining a number of times in which the obtained same confirmation response signals appear at least a designated number of times n; and
means for calculate at least any of a number of times in which the same confirmation response signals appear, a number of times of a data loss, or a data loss rate based on the obtained number of times.
